(19) United States
(12) Patent Application Publication
(10) Pub. No.: US 2009/0321661 A1
(43) Pub. Date: Dec. 31, 2009

(54) DETECTING METHOD, DETECTION SAMPLE CELL, AND DETECTING KIT

(75) Inventor: Hisashi Ohtsuka, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/492,717

(22) Filed: Jun. 26, 2009

(30) Foreign Application Priority Data
Jun. 27, 2008 (JP) 2008-168690

(51) Int. Cl. G01N 21/64; G01N 21/05; G01N 21/76

(52) U.S. Cl. 250/459.1; 356/246; 250/458.1; 436/172; 250/576

(57) ABSTRACT

A fluorescent substance having fluorescent pigment molecules, which are enveloped in a light transmitting material that transmits fluorescence generated by the fluorescent pigment molecules, is employed as fluorescent labels in a detecting method the detects the amount of a detection target substance based on the amount of light which is generated due to excitation of the fluorescent labels. The fluorescent substance is excited by evanescent waves which are generated due to leakage from an optical waveguide mode.

### BACKGROUND OF THE INVENTION

1. Field of the Invention

The present invention is related to a detecting method, for detecting detection target substances within samples, a detection sample cell and a detecting kit. More particularly, the present invention is related to a detecting method, a detection sample cell and a detecting kit that utilizes an optical waveguide mode.

2. Description of the Related Art

Fluorometry is conventionally used in biological measurements and the like, as an easy and highly sensitive measuring method. In fluorometry, a sample, which is considered to contain a detection target substance that emits fluorescence when excited by light having a specific wavelength, is irradiated with an excitation light beam of the aforementioned specific wavelength. The presence of the detection target substance can be confirmed by detecting the fluorescence due to the excitation. In the case that the detection target substance is not a fluorescent substance, a substance labeled by a fluorescent substance that specifically bonds with the detection target substance is caused to contact the sample. Thereafter, fluorescence is detected in the same manner as described above, thereby confirming the presence of the bond, that is, the detection target substance.

With recent advances in the performance of photodetectors, such as cooled CCD's, fluorometry has become indispensable in biological research. In addition, fluorescent pigments having fluorescence quantum yields that exceed 0.2, which is the standard for practical use, such as FITC (fluorescence: 525 nm, fluorescence quantum yield: 0.6) and Cy5 (fluorescence: 680 nm, fluorescence quantum yield: 0.3) have been developed as fluorescent labeling materials and are being widely used.

In addition, high sensitivity detection on the order of 1 pM and less is being realized, by amplifying fluorescence signals employing electric field enhancing fields caused by Plasmon of metal layers, as described in M.M.L.M Vareiro et al., “Surface Plasmon Fluorescence Measurements of Human Chorionic Gonadotrophin: Role of Antibody Orientation in Obtaining Enhanced Sensitivity and Limit of Detection”, Analytical Chemistry, Vol. 77, pp. 2426-2431, 2005. This method is referred to as surface plasmon electric field enhanced fluorescent spectroscopy (SPF).

Further, it has been reported that high sensitivity detection is also enabled by amplifying fluorescence signals employing the electric field enhancing effect of optical waveguide modes, in which the leakage length of evanescent waves is great, in K. Tsuboi et al., “High Sensitivity Detection of Catecholamine Employing Optical Waveguide Mode Enhanced Fluorescence Observation”, the Japan Society of Applied Physics, Abstracts for the 54^{th} Applied Physics Academic Symposium, pp. 1378 (28p-SA-4), 2007.

However, there is desire for greater improvements in S/N ratios. To this end, it is necessary not only to reduce the amount of noise, but to enhance fluorescent intensity to a higher degree.

### SUMMARY OF THE INVENTION

The present invention has been developed in view of the foregoing circumstances. It is an object of the present invention to provide a detecting method, a detection sample cell and a detecting kit that enable high sensitivity detection with high quantitative properties.

A detecting method of the present invention comprises the steps of:

preparing a sensor chip having a metal layer and an optical waveguide layer provided in this order on a surface of a dielectric plate;

causing a sample to contact the optical waveguide layer, to cause an amount of a fluorescent labeling substance corresponding to the amount of a detection target substance included in the sample to bind onto the optical waveguide layer;

causing an excitation light beam to enter the interface between the dielectric plate and the metal layer from the side of the dielectric plate such that conditions for total reflection are satisfied, thereby generating first evanescent waves at the interface;

causing the first evanescent waves to couple with an optical waveguide mode within the optical waveguide layer, thereby generating second evanescent waves at the upper surface of the optical waveguide layer;

exciting fluorescent labels of the fluorescent labeling substance with the second evanescent waves; and

detecting the amount of the detection target substance, based on the amount of light which is generated due to excitation of the fluorescent labels;

a fluorescent substance having fluorescent pigment molecules which are enveloped in a light transmitting material that transmits fluorescence generated by the fluorescent pigment molecules being employed as the fluorescent labels.

Here, the term “fluorescent labeling substance” may be the detection target substance to which the fluorescent labels have been attached, or may be a competing substance that competes with the detection target substance. That is, in the case that assays are to be performed by the sandwich method, the term “fluorescent labeling substance” refers to the detection target substance to which the fluorescent labels have been attached. On the other hand, in the case that assays are to be performed by the competition method, the term “fluorescent labeling substance” refers to a competing substance that competes with the detection target substance. The detecting method of the present invention is capable of performing assays by both the sandwich method and the competition method.

The term “light which is generated due to excitation of the fluorescent labels” is light which is generated either directly or indirectly by the excitation of the fluorescent labels. The term “light which is generated due to excitation of the fluorescent labels” refers to light of which the generated amount has a correlation with the number of excited fluorescent labels.

The phrase “detecting the amount of the detection target substance” refers also to detecting whether the detection target substance is present in the sample. That is, the phrase refers both to quantitative detection and qualitative detection.

A single fluorescent pigment molecule may be enveloped in the light transmitting material, but it is preferable for a plurality of fluorescent pigment molecules to be enveloped in the light transmitting material. Note that in the case that the fluorescent substance includes a plurality of fluorescent pigment molecules, a portion of the fluorescent pigment molecules may be exposed to the exterior of the light transmitting, as long as at least one fluorescent pigment molecule is enveloped therein.

In the detecting method of the present invention, it is preferable for the particle size of each particle of the fluorescent substance to be less than or equal to 5300 nm, and more preferable for the particle size of the fluorescent substance to be within a range from 100 nm to 700 nm. Note that in the present specification, the term “particle size” refers to the diameter of each particle of the fluorescent substance in the case that the particles of the fluorescent substance are spherical. In the case that the particles of the fluorescent substance are not spherical, the term “particle size” is defined as the mean lengths of the greatest and smallest dimensions thereof.

Metal coating films of thicknesses that transmit the fluorescence may be provided on the surfaces of the fluorescent substance.

The optical waveguide layer is preferably of a laminated structure that includes at least one internal optical waveguide layer constituted by optical waveguiding material. In this case, it is preferable for the laminated structure to be of an alternating laminated structure, in which the internal optical wave guide layer and an internal metal layer are provided in this order from the side of the metal layer.

The light which is generated due to the excitation of the fluorescent labels and detected may be fluorescence, which is emitted by the fluorescent labels due to excitation. Alternatively, the light which is generated due to the excitation of the fluorescent labels and detected may be radiant light, which is radiated from surface plasmon excited by fluorescence generated by the fluorescent labels due to excitation toward the dielectric plate.

A detection sample cell of the present invention is a detection sample cell, to be utilized in a detecting method that detects the amount of a detection target substance based on the amount of light which is generated due to excitation of fluorescent labels, comprising:

a base having a channel through which liquid samples are caused to flow;

an injection opening provided at an upstream side of the channel for injecting the liquid samples into the channel;

an air aperture provided at a downstream side of the channel for causing the liquid samples which have been injected from the injection opening to flow downstream;

a sensor chip portion provided within the channel between the injection opening and the air aperture, comprising a dielectric plate which is provided as a portion of an inner wall of the channel, a metal layer and an optical waveguide layer which are provided on a predetermined region of the dielectric plate on the sample contacting surface thereof;

a first binding substance that specifically binds with the detection target substance, immobilized onto the optical waveguide layer;

a fluorescent substance modified with one of: a second binding substance that specifically binds with the detection target substance, immobilized onto the channel upstream of the sensor chip portion; and modified with a third binding substance that specifically binds with the first binding substance and competes with the detection target substance.

A detecting kit of the present invention is a detecting kit to be utilized in a detecting method that detects the amount of a detection target substance based on the amount of light which is generated due to excitation of fluorescent labels, comprising:

a detection sample cell equipped with: a base having a channel through which liquid samples are caused to flow; an injection opening provided at an upstream side of the channel for injecting the liquid samples into the channel; an air aperture provided at a downstream side of the channel for causing the liquid samples which have been injected from the injection opening to flow downstream; a sensor chip portion provided within the channel between the injection opening and the air aperture, comprising a dielectric plate which is provided as a portion of an inner wall of the channel, a metal layer and an optical waveguide layer which are provided on a predetermined region of the dielectric plate on the sample contacting surface thereof; a first binding substance that specifically binds with the detection target substance, immobilized onto the optical waveguide layer; and

a labeling solution which is caused to flow into the channel after the liquid sample, including a fluorescent substance modified with one of: a second binding substance that specifically binds with the detection target substance, immobilized onto the channel upstream of the sensor chip portion; and modified with a third binding substance that specifically binds with the first binding substance and competes with the detection target substance.

In cases that detection sample cell and the detecting kit of the present invention comprise the second binding substance that specifically binds with the detection target substance, the detection sample cell and the detecting kit are favorable for use in sandwich method assays. In cases that detection sample cell and the detecting kit of the present invention comprise the fluorescent substance modified with the third binding substance that specifically binds with the first binding substance and competes with the detection target substance, the detection sample cell and the detecting kit are favorable for use in competition method assays.

Here, the term “fluorescent substance” is that in which fluorescent pigment molecules are enveloped in light transmitting materials.

A single fluorescent pigment molecule may be enveloped in the light transmitting material, but it is preferable for a plurality of fluorescent pigment molecules to be enveloped in the light transmitting material. Note that in the case that the fluorescent substance includes a plurality of fluorescent pigment molecules, a portion of the fluorescent pigment molecules may be exposed to the exterior of the light transmitting, as long as at least one fluorescent pigment molecule is enveloped therein.

In the detection sample cell and the detecting kit of the present invention, it is preferable for the particle size of the fluorescent substance to be less than or equal to 5300 nm, and more preferable for the particle size of the fluorescent substance to be within a range from 100 nm to 700 nm.

Metal coating films of thicknesses that transmit the fluorescence may be provided on the surfaces of the fluorescent substance.

The optical waveguide layer is preferably of a laminated structure that includes at least one internal optical waveguide layer constituted by optical waveguiding material. In this case, it is preferable for the laminated structure to be of an alternating laminated structure, in which the internal optical wave guide layer and an internal metal layer are provided in this order from the side of the metal layer.

The detecting method, the detection sample cell and the detecting kit of the present invention employ optical waveguide mode enhanced fluorescence spectroscopy, which utilizes optical waveguide modes to excite fluorescent substances. Specifically, excitation of the fluorescent substances is performed not by evanescent waves which are generated by total reflection of excitation light beams (first evanescent waves) as in conventional SPF, but by evanescent waves which are generated due to leakage from optical waveguide modes (second evanescent waves). The electric fields of second evanescent waves attenuate more gradually than those of the first evanescent waves, and the second evanescent waves have long leakage lengths (distances at which electric field enhancing intensities become 1/e on detection surfaces).

The second evanescent waves having the longer leakage lengths are maximally utilized, to efficiently excite the fluorescent pigment molecules within the fluorescent substance, and as a result, detection at higher sensitivities and having greater quantitative properties is enabled.

### BRIEF DESCRIPTION OF THE DRAWINGS

FIG. 1 is a sectional diagram that schematically illustrates an example of the placement of optical components to induce an optical waveguide mode.

FIG. 2 is a graph that schematically illustrates the relationship between incident angles of incident light and generation of the optical waveguide mode.

FIG. 3A is a diagram that schematically illustrates the construction of a fluorescence detecting apparatus according to a first embodiment of the present invention.

FIG. 3B is a diagram that schematically illustrates the construction of a radiant light detecting apparatus according to a second embodiment of the present invention.

FIG. 4 is a diagram that schematically illustrates the construction of a fluorescence detecting apparatus according to a third embodiment of the present invention.

FIG. 5A is a plan view that illustrates the construction of a sample cell which is utilized in the fluorescence detecting apparatus of the third embodiment.

FIG. 5B is a cross sectional side view of the sample cell of FIG. 5A.

FIG. 6 is a diagram that illustrates the steps of an assay which is performed employing the sample cell utilized in the fluorescence detecting apparatus of the third embodiment.

FIG. 7A is a first alternative example of how antibodies B1 are immobilized on an optical waveguide layer.

FIG. 7B is a second alternative example of how antibodies B1 are immobilized on the optical waveguide layer.

FIG. 8 is a graph that illustrates the relationship between particle sizes of fluorescent substances and dispersion times.

FIG. 9A is a diagram that schematically illustrates electric fields E which are generated in the case that only a water solvent layer is present on a metal film.

FIG. 9B is a diagram that schematically illustrates electric fields E which are generated in the case that a anti quenching substance is present on a metal film.

FIG. 10 is a graph that illustrates simulated relationships between the incident angle of an excitation light beam into an interface and reflectance in the cases illustrated in FIG. 9A and FIG. 9B.

FIG. 11 is a graph that illustrates the relationship between particle sizes of fluorescent substances and detected fluorescent intensities.

FIG. 12 is a graph that illustrates calibration curve data for the fluorescent substance.

FIG. 13A is a plan view that illustrates the construction of a sample cell which is utilized in a fluorescence detecting apparatus according to a fourth embodiment of the present invention.

FIG. 13B is a cross sectional side view of the sample cell of FIG. 13A.

FIG. 13C is a diagram that illustrates a labeling solution which is utilized in the fluorescence detecting apparatus according to the fourth embodiment.

FIG. 14 is a diagram that illustrates the steps of an assay which is performed employing a detecting kit of the present invention.

FIG. 15 is a diagram that schematically illustrates a particle of a fluorescent substance having a metal coating film.

FIG. 16 is a diagram that illustrates an alternate example of an excitation light beam emitting optical system.

FIGS. 17A, 17B, and 17C are diagrams for schematically illustrating the principles of the competition method.

FIG. 18 is a diagram that illustrates the steps of an assay which is performed employing a sample according to an alternate embodiment of the present invention.

FIG. 19A is a schematic sectional view that illustrates the structure of a sensor chip according to Example 1 of the present invention.

FIG. 19B is a schematic sectional view that illustrates the structure of a sensor chip according to Example 2 of the present invention.

FIG. 19C is a schematic sectional view that illustrates the structure of a sensor chip according to Example 3 of the present invention.

FIG. 19D is a schematic sectional view that illustrates the structure of a sensor chip according to a Comparative Example.

FIG. 20 is a graph that illustrates the relationship between the electric field enhancing intensities and distances from the surfaces of the sensor chips of Examples 1 through 3 and the Comparative Example.

FIG. 21 is a graph that illustrates the degrees of fluorescent signal enhancement by the sensor chips of Examples 1 through 3 and the Comparative Example.

### BEST MODE FOR CARRYING OUT THE INVENTION

Hereinafter, embodiments of the present invention will be described with reference to the attached drawings. However, the present invention is not limited to the embodiments to be described below.

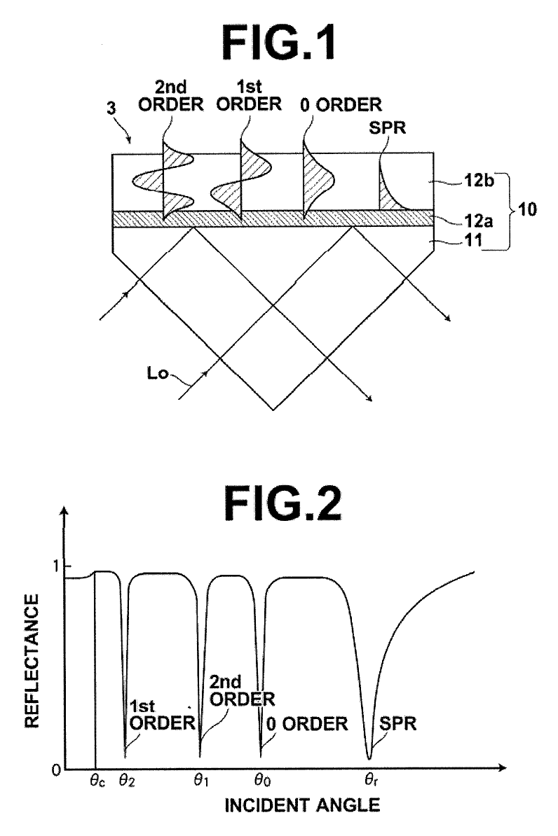

The present invention utilizes an optical waveguide mode. Therefore, the optical waveguide mode and OWF, which utilizes the optical waveguide mode, will be described briefly with reference to FIG. 1.

Note that the optical waveguide mode refers to a state in which light propagates while trapped within a limited space, and is based on multiple reflection which occurs within optical waveguide paths of dielectrics and the like. The propagating state of light within an optical fiber is an example of a well known optical waveguide mode. In an optical fiber, a portion having a high refractive index (generally referred to as a “core”) is formed at the center of a material having a low refractive index in the form of a fiber (generally, an extremely elongated cylinder). Reflection of light, generated due to the difference in refractive indices, causes the light to propagate through the optical fiber while trapping it within the core. Slab type optical waveguide paths, in which light propagates through planar materials which are sandwiched by substances having low refractive indices (including air and vacuums) are also well known.

FIG. 1 is a diagram that illustrates an example of a sensor chip that realizes an optical waveguide mode in OWF. The sensor chip 3 is constituted by: a dielectric prism 11; a metal layer 12a provided on the upper surface of the dielectric prism 11; and an optical waveguide layer 12b provided on the metal layer 12a. At this time, if the upper side (the exposed surface) of the optical waveguide layer 12b is in contact with a substance having a lower refractive index than the optical waveguide layer 12b (such as air or water), the construction of the optical waveguide layer 12b is similar to that of a slab type optical waveguide path. A state in which light propagates while trapped in the optical waveguide layer 12b is the optical waveguide mode as referred to in the present specification.

An optical system which is the same as an optical system utilized in SPF is employed to irradiate an incident light beam Lo onto the sensor chip 3. Thereby, evanescent waves (first evanescent waves) are generated due to total reflection of the incident light beam, and assume an optical waveguide mode by multiple reflection within the optical waveguide layer 12b. Then, evanescent waves (second evanescent waves) are generated on the optical waveguide layer 12b due to leakage of the optical waveguide mode.

That is, the incident light beam Lo, which enters the interface between the dielectric prism 11 and the metal layer 12a from the side of the dielectric prism 11 such that conditions for total reflection are satisfied, passes through the dielectric prism 11, is totally reflected at the interface, and causes the first evanescent waves to be generated toward the side of the optical waveguide layer 12b. If the incident angle of the incident light beam Lo is changed in a state in which the first evanescent waves are being generated, the first evanescent waves propagate through the optical waveguide layer 12b at a specific incident angle. This state is referred to as “the first evanescent waves couple with an optical waveguide mode”, or “an optical waveguide mode is induced”. When the first evanescent waves are coupled to the optical waveguide mode, a portion or the entirety of the first evanescent waves propagate through the optical waveguide layer 12b while being trapped therein. A portion of the trapped light leaks toward the exterior of the optical waveguide layer 12b, to become the aforementioned second evanescent waves.

In OWF, the second evanescent waves which are generated in the manner described above are employed to excite an amount of fluorescent labels corresponding to a detection target substance on the optical waveguide layer. Fluorescence which is generated due to the excitation of the fluorescent labels is detected, and the amount of the detection target substance is detected, based on the detected amount of fluorescence.

Note that there is not necessarily a single optical waveguide mode. There may be cases in which a plurality of optical waveguide modes are present at different positions with a specific incident angle, depending on conditions such as the thickness of the optical waveguide layer 12b and the refractive index thereof. FIG. 1 illustrates the concepts of y component electric fields of a 0 order (reference) optical waveguide mode TE₀, a first order optical waveguide mode TE₁, and a second order optical waveguide mode TE₂ as TE (Transverse Electric) modes. Note that FIG. 1 also illustrates the concept of the state of an electric field due to SPR.

The specific incident angle can be confirmed by monitoring a reflected light beam (the totally reflected incident light beam Lo). This is because there is a drastic increase or a drastic decrease in the reflected light beam when the first evanescent waves couple with the optical waveguide mode.

For example, FIG. 2 is a conceptual diagram that illustrates the relationship between incident angles of a p polarized incident light beam and reflectance rates. FIG. 2 illustrates sharp dips at four locations (θ_{c} is a critical angle). There are two main causes for these dips in reflectance rates.

One cause is due to surface plasmon resonance (SPR). The dip in reflectance rate which occurs at incident angle θᵣ corresponds to SPR. SPR is a phenomenon that occurs when a metal having a negative dielectric constant, particularly precious metals such as Au and Ag, is employed as the metal layer. This phenomenon occurs regardless of whether the optical waveguide layer 12b is present.

The other cause is due to the optical waveguide mode. The dips in reflectance rate which occurs at incident angles θ₀, θ₁, and θ₂ correspond to the optical waveguide mode. These dips in reflectance rates do not occur in cases that the optical waveguide layer 12b illustrated in FIG. 1 is not present, or in cases that the optical waveguide layer 12b is thin. The minimum thickness of optical waveguide layers that enables optical waveguide modes to occur differs depending on the wavelengths and polarization states of incident light beams, the refractive indices of the optical waveguide layers, and the like. Generally, optical waveguide layers may be thin in cases that the refractive indices thereof are great, and also in cases that the wavelengths of incident light beams are short. On the other hand, optical waveguide layers must be thick in cases that the refractive indices thereof are small, and in cases that the wavelengths of incident light beams are long.

As described above, SPR and optical waveguide modes can be observed in similar optical systems. However, the angle at which SPR occurs and the angle at which the first evanescent waves couple with an optical waveguide mode are generally different. In addition, the increase or decrease in reflectance rate that occurs due to SPR is a phenomenon which is generated only in cases that incident light beams are p polarized light beams. However, the increase or decrease in reflectance rate that occurs due to the optical waveguide mode occurs in cases that incident light beams are p polarized light beams and in cases that incident light beams are s polarized light beams. Another characteristic of the optical waveguide mode is that when increases or decreases in reflectance rates occur due to the optical waveguide mode, the optical waveguide mode occurs at a greater number of positions at a specific incident angle as the thickness of the optical waveguide layer is thicker, and that sharp increases (protrusive peaks) in the reflectance rate occur when the incident light beam is s polarized.

The second evanescent waves have the characteristics that the electric fields thereof attenuate more gradually than those of the first evanescent waves, and the second evanescent waves have long leakage lengths. Higher order optical waveguide modes have less trapping effects with respect to light, and the leakage lengths thereof are longer.

### First Embodiment

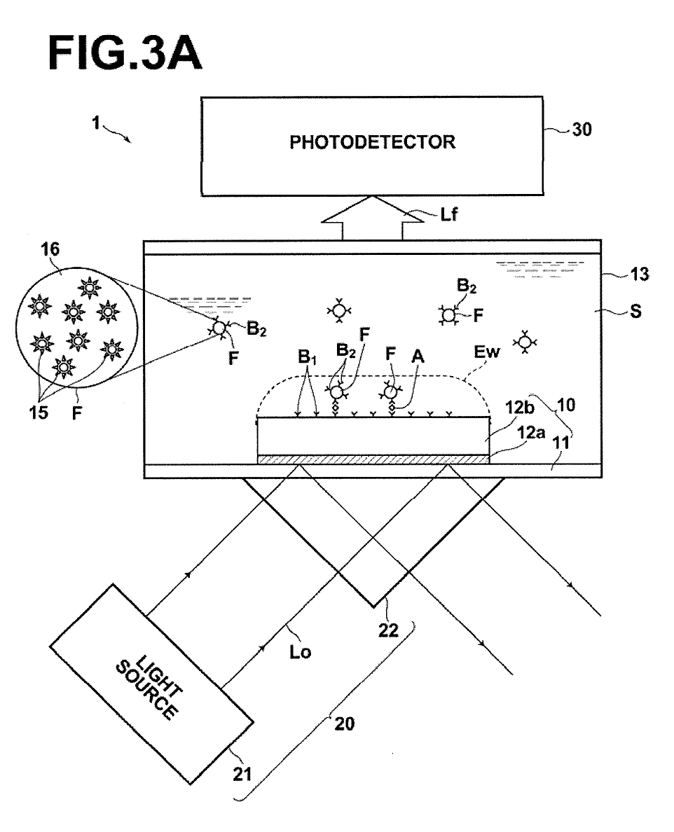

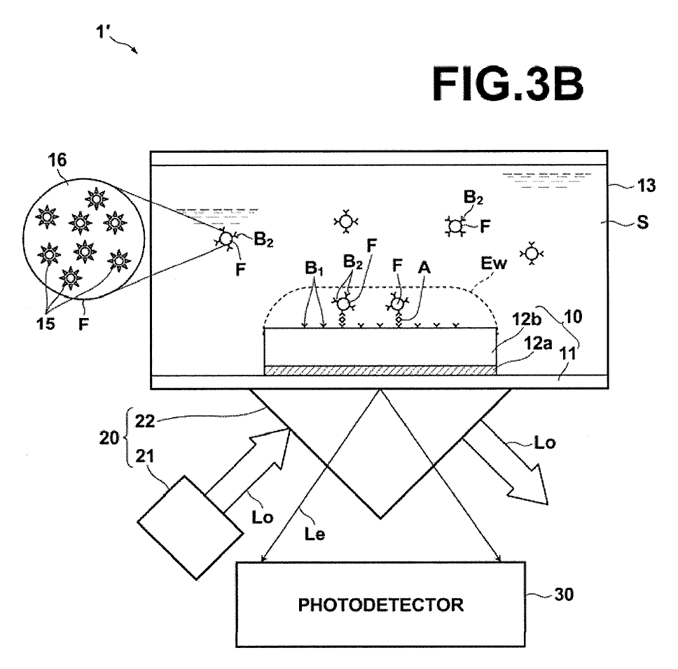

A detecting method according to a first embodiment of the present invention and a fluorescence detecting apparatus which is used to realize the detecting method will be described with reference to the attached drawings. FIG. 3A is a diagram that illustrates the entirety of the fluorescence detecting apparatus. The dimensions of the components of the apparatus are different in the drawings from the actual dimensions, to facilitate the description thereof.

The detecting method according to the first embodiment comprises the steps of: preparing a sensor chip 10 having a metal layer 12a and an optical waveguide layer 12b provided in this order on a surface of a dielectric plate 11; causing a sample that includes a detection target substance A and a fluorescent labeling substance to contact the optical waveguide layer 12b; causing an excitation light beam Lo to enter the interface between the dielectric plate 11 and the metal layer 12a from the side of the dielectric plate 11 such that conditions for total reflection are satisfied, thereby generating first evanescent waves (not shown) at the interface; causing the first evanescent waves to couple with an optical waveguide mode within the optical waveguide layer 12b, thereby generating second evanescent waves Ew at the upper surface of the optical waveguide layer 12b; exciting a fluorescent substance F of the fluorescent labeling substance with the second evanescent waves Ew; detecting the fluorescence emitted by the fluorescent substance F due to the excitation thereof; and detecting the amount of the detection target substance A, based on the amount of detected fluorescence.

A fluorescence detecting apparatus 1 that executes the detecting method according to the first embodiment described above is equipped with: a sensor chip 10 comprising the dielectric plate 11, the metal layer 12a which is provided at a predetermined region on a surface of the dielectric plate 11, and the optical waveguide layer 12b which is provided on the metal layer 12a; an excitation light emitting optical system 20, for emitting the excitation light beam Lo such that it enters the interface between the dielectric plate 11 and the metal layer 12a through the dielectric plate 11 at an incident angle that satisfies conditions for total reflection; and a photodetector 30, for detecting fluorescence Lf emitted from the fluorescent substance F in the case that a sample S which is in contact with the optical waveguide layer 12b includes the detection target substance A having the fluorescent substance F attached thereto.

The excitation light emitting optical system 20 is equipped with: a light source 21, constituted by a semiconductor laser (LD) or the like, for outputting the excitation light beam Lo; and a prism 22, which is provided such that one of the surfaces thereof is in contact with the dielectric plate 11. The prism 22 guides the excitation light beam Lo into the dielectric plate 11 such that the excitation light beam Lo is totally reflected at the interface between the dielectric plate 11 and the metal layer 12a. Note that the prism 22 and the dielectric plate 11 are in contact via refractive index matching oil. The light source 21 is positioned such that the excitation light beam Lo enters the interface at an angle greater than or equal to a total reflection angle, through another surface of the prism 22. Further, light guiding members may be provided between the light source 21 and the prism 22 as necessary. Note that the excitation light beam Lo enters the interface as p polarized light, in order to effectively induce the first evanescent waves.

The sensor chip 10 is constituted by the metal layer 12a and the optical waveguide layer 12b being formed on a predetermined region on the surface of the dielectric plate 11, which is a glass plate or the like.

The metal layer 12a is formed on the surface of the dielectric plate 11 using a mask having an opening at the predetermined region. The metal layer 12a may be formed by known film forming methods such as the vapor deposition method and the sputtering method. It is preferable for the thickness of the metal layer 12a to be determined such that surface plasmon is strongly excited, taking the material of the metal layer 12a and the wavelength of the excitation light beam Lo into consideration. For example, in the case that a laser beam having a central wavelength of 780 nm is employed as the excitation light beam Lo, and an Au film is employed as the metal layer 12a, a favorable thickness of the metal layer 12a is 40 nm±30 nm. In this case, it is more preferable for the thickness of the metal layer 12a to be 40 nm±10 nm. Note that it is preferable for the metal layer 12a to be a metal having at least one of Au, Ag, Cu, Al, Pt, Ni, Ti, and alloys thereof as a main component. Here, the term “main component” is defined as a component which is included in the metal at 90 weight % or greater.

The optical waveguide layer 12b is formed on the metal layer 12a, and may be formed by a method similar to that which is employed to form the metal layer 12a. The thickness of the optical waveguide layer 12b is not particularly limited, and may be determined such that the optical waveguide mode is induced, taking the wavelength and incident angle of the excitation light beam Lo and the refractive index of the optical waveguide layer 12b into consideration. For example, in the case that a laser beam having a central wavelength of 780 nm is employed as the excitation light beam Lo and a silicon oxide film is employed as the optical waveguide layer 12b, it is preferable for the thickness of the optical waveguide layer 12b to be within a range from 500 nm to 600 nm. It is preferable for the optical waveguide layer 12b to be of a laminated structure that includes at least one internal optical waveguide layer constituted by optical waveguiding material. It is preferable for the laminated structure to be of an alternating laminated structure, in which the internal optical wave guide layer and an internal metal layer are provided in this order from the side of the metal layer 12a. Examples of the waveguiding material include: inorganic oxide films, such as SiO₂, TiO₂, and HfO₂; and organic polymers, such as polystyrene and PMMA. By adopting this type of laminated structure, the leakage length of the second evanescent waves Ew can be controlled. Further, by the internal optical waveguide being of a configuration in which it is sandwiched between the metal layer 12a and the internal metal layer (a resonator structure), an enhancing effect due to light being trapped can be expected. In addition, in the case that the internal metal layer is present at the surface, an enhancing effect due to plasmon may also be expected under certain conditions.

Note that in the first embodiment, the sensor chip 10 is equipped with a sample holding portion 13 for holding liquid samples S. The sensor chip 10 and the sample holding portion 13 constitute a box shaped cell which is capable of holding liquid samples S. Note that the sample holding portion 13 may not be provided, in cases that a slight amounts of liquid samples S, which can be held on the sensor chip 10 by surface tension, are to be measured.

Hereinafter, the principles of the detecting method according to the first embodiment and fluorescence detection employing the fluorescence detecting apparatus will be described. First, the method by which the fluorescent substance F is excited in the detecting method of the first embodiment is as follows.

The excitation light emitting optical system 20 causes the excitation light beam Lo to enter the interface between the dielectric plate 11 and the metal layer 12a at a specific angle greater than or equal to a total reflection angle, thereby generating the first evanescent waves (not shown) at the interface. The first evanescent waves couple with an optical waveguide mode, thereby generating the second evanescent waves Ew at the surface of the optical waveguide layer 12b which is in contact with the liquid sample S. The second evanescent waves Ew form an electric field enhancing region on the surface of the optical waveguide layer 12b. In the case that the fluorescent substance F is present within the electric field enhancing region formed by the second evanescent waves Ew, the fluorescent substance F is excited and fluorescence Lf is generated. Note that the fluorescent substance F outside of the electric field enhancing region are not excited, and does not emit the fluorescence Lf. The photodetector 30 detects the emitted fluorescence Lf.

In the first embodiment, each particle of the fluorescent substance F has a plurality of fluorescent pigment molecules 15 enveloped in a light transmitting material 16. Therefore, the amount of emitted fluorescence can be greatly increased compared to conventional cases in which single fluorescent pigment molecules 15 are employed as fluorescent labels.

Note that it is preferable for the particle size of each particle of the fluorescent substance F to be less than or equal to 5300 nm, and more preferable for the particle size of the fluorescent substance to be within a range from 100 nm to 700 nm. The most preferred range of article sizes for each particle of the fluorescent substance F is within a range from 130 nm to 500 nm. Specific examples of the light transmitting material 16 include polystyrene and SiO₂. However, the light transmitting material 16 is not particularly limited, as long as it is capable of enveloping the fluorescent pigment molecules 15 and transmitting the fluorescence Lf emitted by the fluorescent pigment molecules 15 toward the exterior.

A sensing operation performed according to the detecting method that employs the fluorescence detecting apparatus 1 having the construction described above will be described.

First, a sample S which is a target of inspection, is placed in contact with the optical waveguide layer 12b of the sensor chip 10. An example will be described in which an antigen A which is included in the sample S is detected as a detection target substance. Primary antibodies B₁ (first binding substance) that specifically bind with the antigens A are immobilized on the optical waveguide layer 12b. The sample S is caused to flow within the sample holding section 13. Next, the fluorescent substance F, the surfaces of which have been modified with secondary antibodies B₂ (second binding substance) that specifically bind to the antigens A, is caused to flow within the sample holding section 13. Then, the excitation light beam Lo is emitted by the excitation light emitting optical system 20 toward the predetermined region of the dielectric plate 11, and the photodetector 30 performs fluorescence detection. At this time, if the photodetector 30 detects the fluorescence Lf, the bonds between the secondary antibodies B₂ and the antigens A, that is, the presence of the antigens A within the sample S, can be confirmed.

Note that the timing at which the detection target substance (the antigens A) is labeled is not particularly limited. Fluorescent labels (the fluorescent substance F) may be added to the sample S prior to causing the detection target substance (the antigens A) to bind with the first binding substance (the primary antibodies B₁).

The fluorescent substance F may be produced in the following manner.

First, a 0.1% solid in phosphate polystyrene solution having a pH of 7.0 and that contains polystyrene particles (product number K1-050 by Estapor, φ 500 nm, 10% solid, carboxyl base) is produced.

Next, 1 ml of a phosphate ethyl solution containing 0.3 mg of fluorescent pigment molecules (NK-2014 by Hayashibara Biochemical, excitation wavelength: 780 nm) is produced.

The polystyrene solution and the fluorescent pigment solution are mixed, and impregnation is performed while evaporating the mixture. Then, the mixture is placed in a centrifuge (15000 rpm, 4° C., 20 minutes, two times), and supernatant liquid is removed.

The foregoing steps result in obtainment of the fluorescent substance F, in which polystyrene that functions to transmit fluorescence emitted from the fluorescent pigment molecules 15 has the fluorescent pigment molecules 15 enveloped therein. The particle size of each particle of the fluorescent substance F which is produced by impregnating the polystyrene particles with the fluorescent pigment molecules 15 is the same as the particle size of the polystyrene particles (φ 500 nm in the example above).

Hereinafter, the advantageous effects of the first embodiment will be described.

In the first embodiment, the fluorescent substance, in which the fluorescent pigment molecules are enveloped within the material that transmits the fluorescence generated by the fluorescent pigment molecules, is used as the fluorescent labels. Thereby, the second evanescent waves having the log leakage lengths are maximally utilized to efficiently excite the fluorescent pigment molecules within the fluorescent substance. Accordingly, highly sensitive detection having high quantitative properties is enabled.

In the case that fluorescence detection is performed employing first evanescent waves, the short leakage length of the first evanescent waves causes a problem. That is, the leakage length of the first evanescent waves are approximately the same as the wavelength of the excitation light beam. The intensity of the electric field enhancing effect of the first evanescent waves attenuates drastically as an index function corresponding to the distance from detection surfaces (metal layers at which surface plasmon is induced). Accordingly, even if the fluorescent substance, in which a plurality of fluorescent pigment molecules are enveloped, is used in order to obtain greater fluorescent signal intensity, the fluorescent substance cannot be efficiently excited. This is a cause of decreases and fluctuations in fluorescent signal intensities.

However, in the detecting method of the present invention, the second evanescent waves, which have electric fields that attenuate more gradually than those of the first evanescent waves and which have long leakage lengths, are utilized to efficiently excite the fluorescent substance. Accordingly, the fluorescent pigment molecules enveloped in the fluorescent substance can be efficiently excited compared to cases in which conventional SPF is employed, even if fluctuations occur in the positions of the fluorescent substance (distances of the fluorescent substance from the detection surface) due to the flow of the sample liquid or physical obstructions. Therefore, decreases and fluctuations in fluorescent signal intensities can be suppressed, and higher sensitivity detection with high quantitative properties is enabled.

In addition, the ordinal number of the optical waveguide mode can be changed by adjusting the incident angle of the excitation light beam and the thickness of the optical waveguide layer, to vary the leakage length of the second evanescent waves. Accordingly, in the detecting method of the present invention, it is possible to control the leakage length of the second evanescent waves according to measurement conditions, the particle size of the fluorescent substance, and the like.

Further, noise that occurs in biological sensing is mainly caused by non specific adsorption of proteins and the like which are present within samples. The main mechanism of adsorption is due to hydrophobic interactions between the detection surface and the proteins. For this reason, causing the surface of metal films to become hydrophilic due to surface modifications is an important objective to achieve high sensitivity detection in SPR. Many inventions have been proposed to resolve the problem of non specific adsorption. In contrast, in the present invention, in the case that the SiO₂ film is employed as the optical waveguide layer, non specific adsorption hardly occurs due to the hydrophilic nature of SiO₂. Accordingly, noise can be reduced without performing complex surface modifications.

Meanwhile, in the case that the optical waveguide layer has the internal metal layer as its outermost surface in the laminated structure thereof, the influence of metallic quenching due to the internal metal layer becomes conspicuous. Therefore, it is necessary to finely control the distances between the internal metal layer and the fluorescent pigment molecules. The degree of metal quenching is inversely proportionate to the distance between the molecules and the metal to the third power in the case that the metal is a plane which is infinitely thick. The degree of metal quenching is inversely proportionate to the distance between the molecules and the metal to the fourth power in the case that the metal is a plane which is infinitely thin. The degree of metal quenching is inversely proportionate to the distance between the molecules and the metal to the sixth power in the case that the metal is in the form of fine particles. Accordingly, it is desirable for a distance of several nm or greater, preferably 10 nm or greater, to be secured between the internal metal film and the fluorescent pigment molecules 15. Control of distances in this manner is generally performed by providing a barrier layer, such as a polymer film, an SiO₂ film, an SAM film and a CMD film on the metal layer. However, the provision of such a barrier layer is troublesome and not suited for practical use. However, in the case that the fluorescent substance of the present invention includes a sufficient number of fluorescent pigment molecules, a certain amount of distance can be secured between the internal metal film and many of the fluorescent pigment molecules, without providing a film for preventing metallic quenching. Thereby, the trouble of providing the CMD film and the SAM film, which had conventionally been necessary to prevent metallic quenching, is obviated, metallic quenching can be effectively prevented by an extremely simple method, and fluorescent signals can be stably detected.

### Second Embodiment

A detecting method and a detecting apparatus 1′ according to a second embodiment of the present invention will be described with reference to FIG. 3B. The radiant light detecting apparatus 1′ illustrated in FIG. 3B differs from the fluorescence detecting apparatus 1 of the first embodiment in the placement position of the photodetector 30. Specifically, the radiant light detecting apparatus 1′ detects radiant light, which is radiated toward the dielectric plate from surface plasmon excited by fluorescence generated by the fluorescent labels due to excitation. Here, elements of the radiant light detecting apparatus 1′ which are the same as those of the fluorescence detecting apparatus 1 will be denoted by the same reference numerals, and detailed descriptions thereof will be omitted insofar as they are not particularly necessary.

Hereinafter, the principles of the detecting method according to the second embodiment will be described.

The excitation light beam Lo is emitted by the excitation light emitting optical system 20 toward the interface between the dielectric plate 11 and the metal layer 12a at the specific incident angle greater than or equal to a total reflection angle, in a manner similar to that of the first embodiment. Thereby, first evanescent waves (not shown) couple with an optical waveguide mode, and second evanescent waves Ew are induced on the optical waveguide layer 12b toward the side of the liquid sample S. The second evanescent waves Ew form an electric field enhancing region on the surface of the optical waveguide layer 12b. At this time, in the case that the fluorescent substance F is present within the electric field enhancing region formed by the second evanescent waves Ew, the fluorescent substance F is excited and fluorescence Lf is generated. Note that the fluorescent substance F outside of the electric field enhancing region are not excited, and does not emit the fluorescence Lf. The fluorescence Lf generated on the optical waveguide layer 12b excites surface plasmon at the metal layer 12a, and radiant light Le is radiated toward the dielectric plate 11 from the interface between the dielectric plate 11 and the metal layer 12a at a specific angle. This phenomenon is referred to as SPCE (Surface Plasmon Coupled Emission). The photodetector 30 is provided to detect the radiant light Le.

The radiant light Le is generated when the fluorescence Lf couples with surface plasmon of a specific wavelength at the metal layer 12a. The wavelength of the fluorescence Lf determines the wavelength at which the couple with the surface plasmon occurs. Therefore, the radiant angle of the radiant light Le is determined according to the wavelength. Generally, the wavelength of the excitation light beam Lo and the wavelength of the fluorescence Lf are different. Therefore, the surface plasmon which is excited by the fluorescence Lf is different from surface plasmon which is excited by the excitation light beam Lo, and accordingly, the radiant light Le is radiated at an angle different from the incident angle of the excitation light beam Lo.

In the detecting method of the second embodiment as well, sensing is performed by attaching the fluorescent substance F onto the detection target substance A as fluorescent labels, in a manner similar to that of the first embodiment. Accordingly, advantageous effects similar to those obtained by the first embodiment are obtained by the second embodiment as well.

Further, the second embodiment utilizes SPCE. Therefore, the distance that the fluorescence Lf travels through media that absorbs light can be reduced to several 10's of nanometers. Accordingly, light absorption by blood, for example, becomes negligible, and measurement becomes possible without performing preliminary processes of removing coloring components such as red blood cells from blood with a centrifuge, and passing blood through blood cell filters to obtain blood serum or plasma.

### Third Embodiment

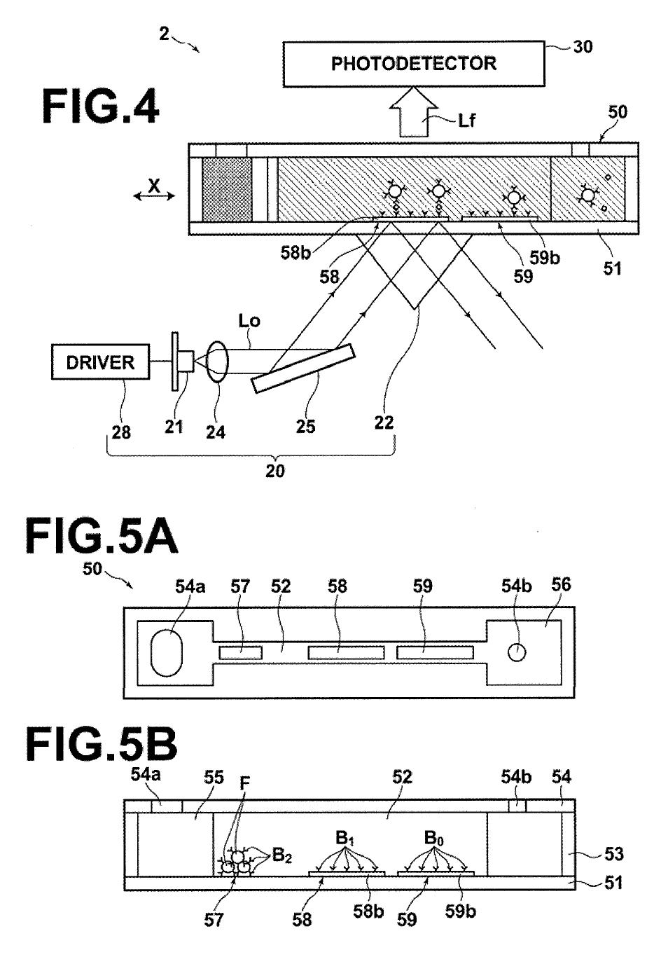

A detecting method and a detecting apparatus 2 according to a third embodiment of the present invention will be described with reference to FIGS. 4 through 6. Here, elements of the fluorescence detecting apparatus 2 which are the same as those of the fluorescence detecting apparatus 1 of the first embodiment will be denoted by the same reference numerals, and detailed descriptions thereof will be omitted insofar as they are not particularly necessary.

The fluorescence detecting apparatus 2 illustrated in FIG. 4 is equipped with a sample cell 50 according to an embodiment of the present invention, which is utilized in the detecting method performed by the fluorescence detecting apparatus 2, the excitation light emitting optical system 20, for emitting the excitation light beam Lo onto a predetermined region of the sample cell, and the photodetector 30, for detecting the fluorescence Lf.

The excitation light emitting optical system 20 is equipped with: the light source 21, constituted by a semiconductor laser (LD), for outputting the excitation light beam Lo; a prism 22, which is provided such that one of the surfaces thereof is in contact with the base 51 of the sample cell 50; a light guiding member constituted by a lens 24 and a mirror 25 for focusing the excitation light beam Lo emitted from the light source 21 and causing it to enter a surface of the prism 22; and a driver 28, for driving the semiconductor laser light source 21.

FIG. 5A is a plan view that illustrates the construction of the sample cell 50, and FIG. 5B is a cross sectional side view of the sample cell 50.

The sample cell 50 is equipped with: the base 51; a spacer 53 for holding the liquid sample S on the base 51 and which forms a channel 52 for the liquid sample S; and an upper plate, which is a glass plate having an injection opening 54a through which the liquid sample S is injected, and an air aperture 54b through which the liquid sample S is expelled after flowing through the channel 52. A membrane filter 55 is provided at a position between the injection opening 54a and the channel 52, and a waste liquid repository is formed at the downstream portion of the channel 52 where the channel 52 connects with the air aperture 54b. Note that the base 51 having the channel 52 constituted by the spacer 53 on the upper surface thereof is a dielectric plate, and functions as the dielectric plate of a sensor chip portion. Alternatively, only the portion of the base 51 that becomes the sensor chip portion may be formed by a dielectric plate.

A labeling secondary antibody adsorption area 57, at which the fluorescent substance F (hereinafter, referred to as “labeling secondary antibodies”), the surfaces of which are modified with secondary antibodies B₂ (second binding substance) that specifically bind to the antigens to be detected is physically adsorbed, a first measuring area 58, at which primary antibodies B₁ (first binding substance) that specifically bind with the antigens to be detected are immobilized, and a second measuring area 59, at which primary antibodies B₀ that do not specifically bind to the antigen to be detected but specifically bind to the labeling secondary antibodies B₂ are immobilized, are provided on the base 51 of the sample cell 50, in this order from the upstream side of the channel 52. The first and second measuring areas 58 and 59 correspond to the sensor chip portion. Note that FIG. 4 illustrates the sample cell 50 in a state after the liquid sample S has been injected, the antibodies have bound with the labeling secondary antibodies, and have flowed downstream. Therefore, the labeling secondary antibodies are no longer present at the labeling secondary antibody adsorption area 57. In the present example, the sensor chip portion is provided with two measuring areas. Alternatively, a single measuring area may be provided.

Au films (not shown) and SiO₂ films (58b and 59b) are provided as the metal layer and the optical waveguide layer on the base 51 at the first measuring area 58 and the second measuring area 59, respectively. Primary antibodies B₁ are immobilized on the SiO₂ film 58b at the first measuring area 58. Primary antibodies B₀, which are different from the primary antibodies B₁, are immobilized on the SiO₂ film 59b at the second measuring area 59. The first measuring area 58 and the second measuring area 59 are of the same construction, except that different primary antibodies are immobilized thereon. The primary antibodies B₀ which are immobilized at the second measuring area 59 do not bind with the antigens A, but directly bind with the labeling secondary antibodies B₂. Thereby, the amount and activity of the labeling secondary antibodies which have flowed through the channel 52, which are factors of variation, and factors of variation due to the enhancing effect of the optical waveguide mode, such as the excitation light emitting optical system 20, the SiO₂ films 58b and 59b, and the liquid sample S, can be detected and utilized for calibration. Note that a known amount of a labeling substance may be immobilized on the second measuring area 59 instead of the primary antibodies B₀. The labeling substance may be the same as the fluorescent substance, the surfaces of which have been modified with secondary antibodies (labeling secondary antibodies B₂). Alternatively, the labeling substance may be a fluorescent substance having a different wavelength and of a different size. Further, the labeling substance may be fine metallic particles. In this case, only the factors of variation due to the enhancing effect of the optical waveguide mode, such as the excitation light emitting optical system 20, the SiO₂ films 58b and 59b, and the liquid sample S, can be detected and utilized for calibration. Whether to provide the labeling secondary antibodies B₂ or the known amount of the labeling substance at the second measuring area 59 may be determined according to the purposes and method of calibration.

The sample cell 50 is movable in the directions indicated by arrow X relative to the excitation light emitting optical system 20 and the photodetector 30. After fluorescence is detected and measured at the first measuring area 58, the sample cell 50 is moved such that the second measuring area 59 is positioned at the fluorescence detecting position, to perform fluorescence detection at the second measuring area 59.

The principles of the detecting method that employs the fluorescence detecting apparatus 2 configured as described above are the same as those of the first embodiment. In the third embodiment as well, the fluorescent substance F is employed as the fluorescent labels, and the second evanescent waves are utilized to excite the fluorescent substance F. Therefore, the same advantageous effects as those obtained by the first embodiment can be obtained, and extremely accurate measurements can be performed.

Sensing that utilizes the fluorescence detecting apparatus 2 and the detecting method of the third embodiment will be described.

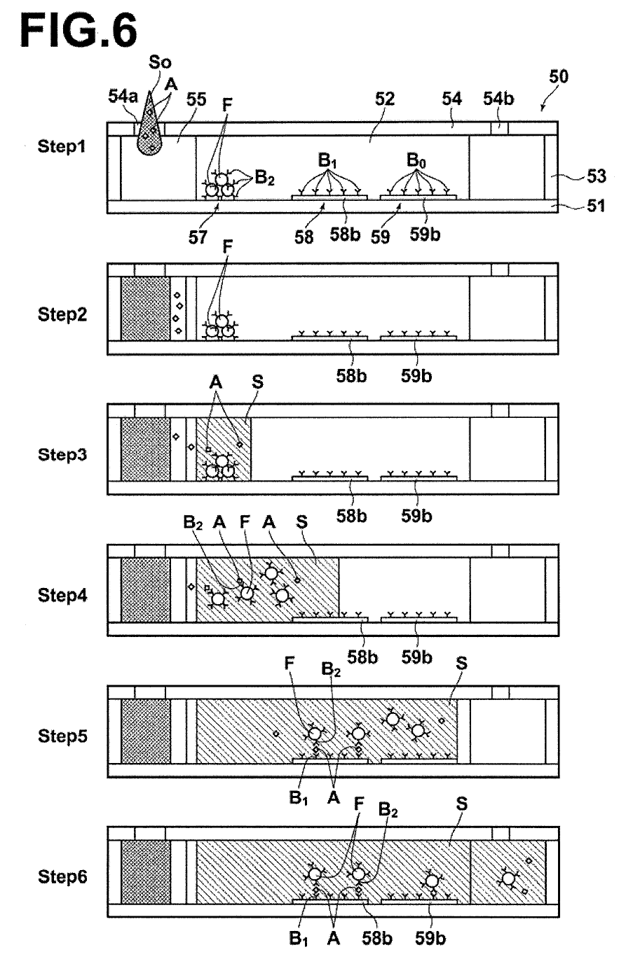

The procedures by which an assay is performed by injecting blood (whole blood) to detect whether an antigen to be detected is included therein will be described with reference to FIG. 6.

Step 1: The blood So (whole blood), which is the target of inspection, is injected through the injection opening 54a. Here, a case will be described in which the blood So includes the antigen A to be detected. In FIG. 6, the blood So is represented by the cross hatched regions.

Step 2: The blood So is filtered by the membrane filter 55, and large molecules, such as red blood cells and white blood cells, are separated as residue.

Step 3: Plasma S (the blood from which blood cells have been filtered out by the membrane filter 55) leaks out into the channel 52 by capillary action. Alternatively, in order to expedite reactions and to shorten detection time, a pump may be connected to the air aperture 54b, and the plasma S may be caused to flow by suctioning and extruding operations of the pump. In FIG. 6, the plasma S is represented by the hatched regions.

Step 4: the plasma S, which has leaked into the channel 52, and the fluorescent substance, to which the secondary antibodies B₂ are attached, mix, and the antigens A within the plasma S bind with the secondary antibodies B₂.

Step 5: the plasma S gradually flows along the channel 52 toward the air aperture 54b, and the antigens A, which are bonded to the labeling secondary antibodies B₂, bind with the primary antibodies B₁, which are immobilized onto the first measuring area 58. So called sandwich configurations, in which the antigens A are sandwiched between the primary antibodies B₁ and the labeling secondary antibodies B₂ is formed.

Step 6: A portion of the labeling secondary antibodies B₂ that did not bind with the antigens A bind with the primary antibodies B₀. Further, even in the case that the labeling secondary antibodies B₂ which did not bind with the antigens A or the primary antibodies B₀ remain, the following plasma S functions as a cleansing agent that washes the labeling secondary antibodies B₂, which are floating or non specifically bound onto the plate, away.

In this manner, the blood So is injected through the injection opening 54a, and step 1 through step 6 are performed to form the sandwich configurations, in which the antigens A are sandwiched between the primary antibodies B₁ and the labeling secondary antibodies B₂, on the first measuring area 58. Thereafter, fluorescent signals are detected at the first measuring area 58, to detect the presence and/or the concentration of the antigens. Next, the sample cell 50 is moved in the X direction so as to enable fluorescent signal detection at the second measuring area 59, and fluorescent signals are detected at the second measuring area 59. The fluorescent signals obtained at the second measuring area 59, at which the primary antibodies B₀ that bind with the labeling secondary antibodies B₂ are immobilized, are considered to be fluorescent signals that reflect reaction conditions such as the amount of the labeling secondary antibodies B₂ which has flowed through the channel 52 and the activity thereof. Therefore, if the fluorescent signals obtained at the second measuring area 59 are used as a reference to correct the fluorescent signals obtained at the first measuring area 58, more accurate detection results can be obtained. In the case that the known amount of the labeling substance (fluorescent substance or fine metallic particles) is immobilized onto the second measuring area 59 in advance as described previously, the fluorescent signals obtained at the second measuring area 59 can be used as a reference to correct the fluorescent signals obtained at the first measuring area 58 as well.

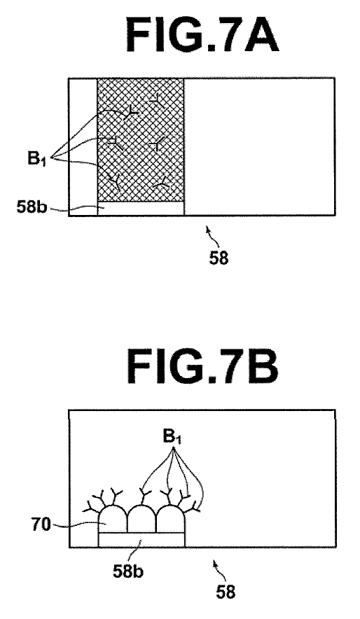

In FIGS. 4 through 6 the primary antibodies B₁ which are immobilized onto the first measuring area 58 are provided two dimensionally on the surface of the optical waveguide layer 58b. Alternatively, the primary antibodies B₁ may be immobilized within the three dimensional region of a membrane provided on the optical waveguide layer 58b, as illustrated in FIG. 7A. As a further alternative, a structure 70 that increases the surface area may be provided on the surface of the optical waveguide layer 58b, and the primary antibodies B₁ may be immobilized on the three dimensional region formed by the structure 70, as illustrated in FIG. 7B.

The material of the structure 70 is not limited, as it is a light transmitting material such as polystyrene or glass. However, it is preferable for the material of the structure 70 to have a low refractive index and a small size (thickness), so as to avoid causing disturbances in the second evanescent waves, as will be described alter. The structure 70 may be produced by forming a thin film by the vapor deposition method, the sputtering method, the spin coat method or the like, then roughening the surface of the thin film with a plasma process or a solvent process. Alternatively, fine polystyrene particles having diameters within a range from 10 nm to 500 nm may be immobilized on the surface of the optical waveguide layer 58b by physical adsorption or by chemical bonding.

When assays are performed by immobilizing the fluorescent substance F onto the wall surfaces of the channel 52 as described in the third embodiment, the motion of the fluorescent substance within the channel is mainly controlled by dispersion. Significant differences appear in the dispersion times of the fluorescent substance F depending on the particle size thereof. Therefore, a preferred range of the particle sizes of the fluorescent substance F was derived as follows. Note that in the following example, a range of particle diameters was derived, assuming that each particle of the fluorescent substance is spherical.

The dispersion time τ of the fluorescent substance is represented by the following Formula (1).

τ=h²/D (1)

wherein h is a dispersion distance, and D is a dispersion constant.

The dispersion constant D is determined by the fluid dynamic radius d of the fluorescent substance using Einstein Stokes' formula (2) below. Therefore, the dispersion time τ required for the fluorescent substance to disperse a distance h (dispersion distance) to the primary antibodies, which are necessary to form the sandwich configurations, is obtained. The dispersion distance h represents the height of the channel in the case that the sandwich configurations are formed on two dimensional surfaces within the channel, and represent the distance to the primary antibodies, which are immobilized on a three dimensional structure, in the case that the sandwich configurations are formed within a three dimensional structure such as a membrane.

D=K_{B}T/3πηd (2)

wherein K_{B} is a Boltzmann constant, T is absolute temperature, η is the viscosity of a medium, and d is the fluid dynamic radius.

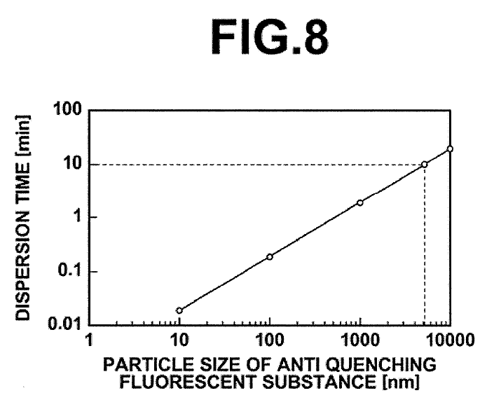

FIG. 8 is a graph that illustrates the time required for the fluorescent substance having diameters 9 to disperse over a distance of 30 μm, which is the distance h to the primary antibodies, which are necessary to form sandwich configurations. Generally, assay times which are practical for diagnostic purposes are 10 minutes or less. From the graph of FIG. 8, it can be said that in order to achieve assay times of 10 minutes or less with a micro flow channel having a height of 30 μm, effective particle sizes of the fluorescent substance is less than or equal to φ 5300 nm. From this finding, it is preferable for the particle size of each particle of the fluorescent substance to be φ 5300 nm or less, with respect to reactions within the micro flow channel.

In fluorescence detection utilizing optical waveguide mode enhancement, it is necessary to take disturbances of second evanescent waves due to the fluorescent substance into consideration.

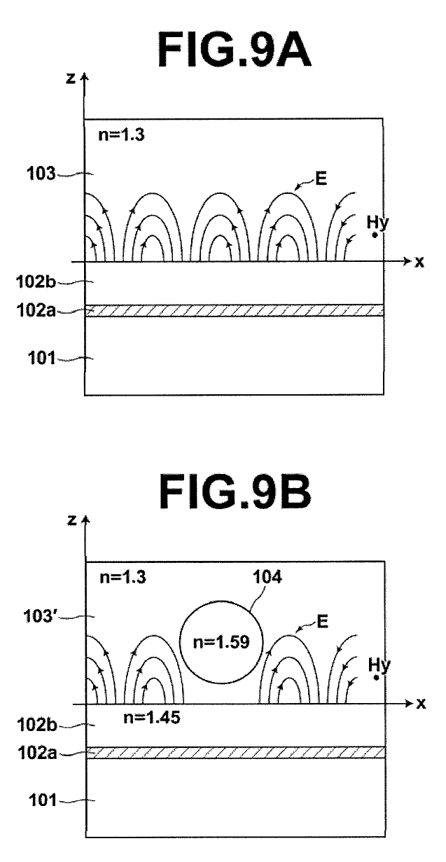

Polystyrene, glass, and the like, which have higher refractive indices than a water solvent (refractive index n=1.33) are used as the material of the fluorescent substance. For example, the refractive index n of polystyrene is within a range from 1.59 to 1.6. The generation of the second evanescent waves is hindered by the fluorescent substance having such a high refractive index being positioned in the vicinity of the metal film. This phenomenon was considered for an approximated multilayer structure divided into a prism layer 101, a metal film 102a (refractive index n<1), an SiO₂ optical waveguide layer 102b (refractive index n=1.45-1.46) and a solvent layer 103. FIG. 9A is a diagram that schematically illustrates electric fields E which are generated on the surface of the SiO₂ optical waveguide layer 102b by a light beam entering through the prism layer 101 in the case that only a water solvent layer is present. FIG. 9B is a diagram that schematically illustrates electric fields E which are generated on the surface of the SiO₂ optical waveguide layer 102b by a light beam entering through the prism layer 101 in the case that a polystyrene fluorescent substance 104 is present on the metal film 102.

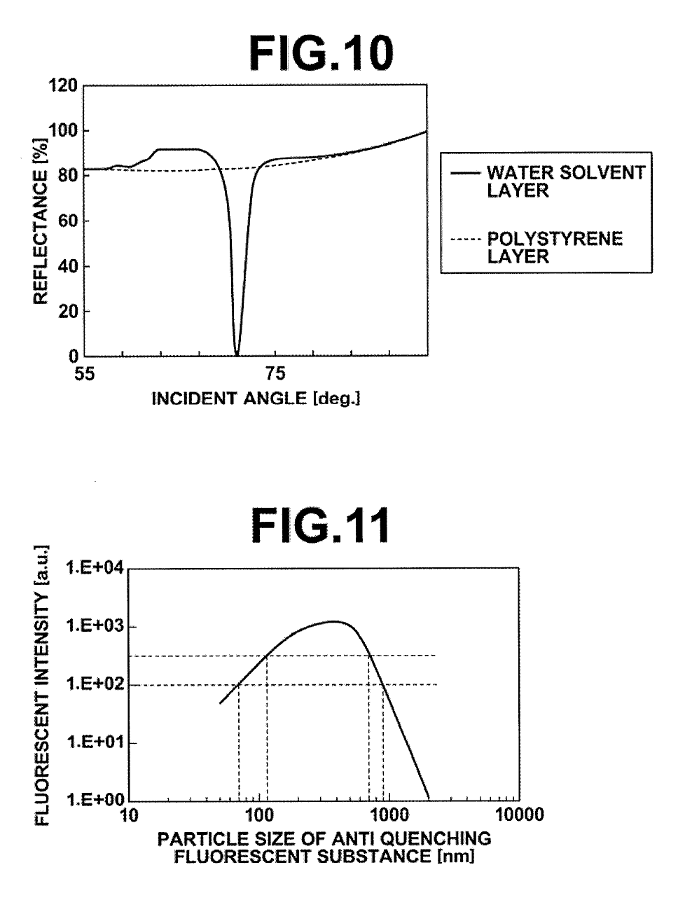

It is assumed that the prism layers 101 and the solvent layer 103 (solvent layer 103′) are of sufficient film thicknesses, and that the refractive index of the prism layer 101, the refractive index of the metal film 102a, the refractive index of the SiO₂ optical waveguide layer 102b, the film thickness of the prism layer 101, the film thickness of the metal film 102a, and the film thickness of the SiO₂ optical waveguide layer 102b are already determined. In this case, the state of the second evanescent waves which is induced on the surface of the SiO₂ optical waveguide layer 102b is determined by the refractive index of the solvent on the SiO₂ optical waveguide layer 102b. FIG. 10 is a graph that illustrates simulated relationships between the incident angle of an excitation light beam into an interface and reflectance in the case that only a water solvent is present on the SiO₂ optical waveguide layer 102b (indicated by the solid line) and in the case that a polystyrene layer is present on the SiO₂ optical waveguide layer 102b (indicated by the broken line). It can be understood from this graph that a resonance angle at which surface plasmon is generated exists in the case that the water solvent (refractive index=1.33) is present, and that second evanescent waves are not generated (a resonance angle does not exist) in the case that the polystyrene layer is present.

This is because the first evanescent waves no longer satisfy the conditions for coupling with the optical waveguide mode within the SiO₂ optical waveguide layer 102b. That is, the SiO₂ optical waveguide layer 102b (having a refractive index n of 1.45) functions as an optical waveguide path by being sandwiched between the metal layer 102a (having a refractive index n of less than 1) and the solvent (having a refractive index n of 1.33), which both have lower refractive indices than the SiO₂ optical waveguide layer 102b. However, because the polystyrene (having a refractive index n of 1.59) is present toward the side of the solvent, total reflection no longer occurs at this interface. For this reason, if a fluorescent substance having a high refractive index (such as polystyrene or glass) is employed to perform assays, and the fluorescent substance is immobilized in the vicinity of the optical waveguide layer 102b, the generation of the second evanescent waves is inhibited, and the electric field intensity thereof is reduced, thereby precluding fluorescence measurement (refer to FIG. 9B).

A simulated relationship that illustrates fluorescence intensities and the particle sizes of fluorescent substances as a result of taking the disturbance of second evanescent waves by fluorescent substances into consideration is illustrated in FIG. 11. The greater the particle size of the fluorescent substance, the greater the number of fluorescent pigment molecules enveloped therein increases. Therefore, the fluorescent intensity increases along with increases in the particle size up to 400 nm. However, it was seen that the fluorescent intensity decreases drastically at particle sizes that exceed 500 nm. This is because the aforementioned disturbance of second evanescent waves by the fluorescent substance becomes greater at particle sizes that exceed 500 nm. From the results illustrated in the graph of FIG. 11, it can be seen that it is desirable for the particle size of the fluorescent substance to be within a range from 70 nm to 900 nm, in order to limit decreases in fluorescent intensity to an order of 10 from the maximum peak thereof, which occurs at a particle size of 300 nm. Note that in the foregoing description, the preferred range of particle sizes was determined assuming that the fluorescent substance is spherical in shape. However, the fluorescent substance may be of shapes other than spheres. In the case that the fluorescent substance is not spherical, average values of the maximum dimensions and minimum dimensions of the particles may be designated as the particle sizes.

Further, the preferred range of particle sizes for the fluorescent substance was derived for cases in which assays are performed on two dimensional surfaces, omitting the trouble of producing three dimensional structures within channels, onto which the primary antibodies are immobilized.

For diagnostic purposes, it is generally necessary for antigen concentrations of approximately 1 pM (pico Mol: ×10⁻¹² mol/L) to be detectable. The preferred range of particle sizes for the fluorescent substance was derived with sensitivity properties that enable detection of antigens at concentrations of 1 pM or less, with a dynamic range of two orders of ten, that is, up to 100 pM as a goal.

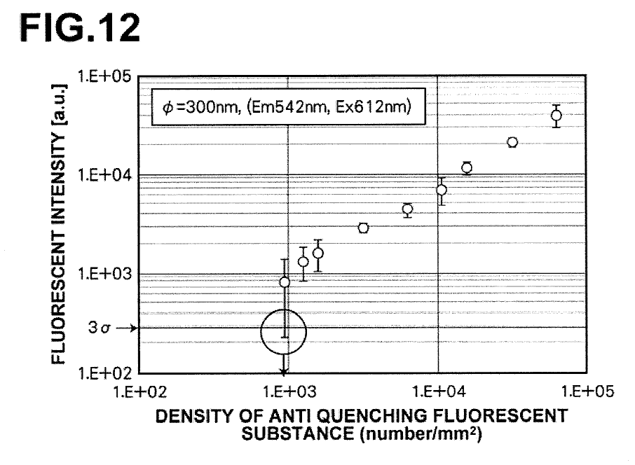

Regarding a specimen having an antigen concentration of 1 pM, assay conditions are assumed to be such that: the diameter of a detection region is 1 mm (area: 3.1 mm²); the amount of the specimen to be caused to flow through a flow channel is 30 μl (this amount is a standard amount for specimens in common blood diagnostic devices, after blood cells are separated by a preliminary process or by a membrane filter); and the antigen capture rate is 0.2% (commonly, antigen capture rates are within a range from approximately 0.2% to approximately 2%; therefore, the antigen capture rate is assumed to be 0.2% such that detection is enabled with the minimum capture rate). In this case, it is necessary to immobilize and detect 1.2×10⁴/mm² antigens at the detection region. Here, 1.2×10⁴/mm² is the target number of antigens to be immobilized. Calibration curve data for an incident light fluorescence detector (LAS-4000 by FUJIFILM) when fluorescent substances (having diameters of 300 nm, an excitation wavelength of 542 nm, and a fluorescent wavelength of 612 nm) produced by the aforementioned steps were measured are illustrated in the graph of FIG. 12. The results illustrated here were obtained by employing excitation light having a central wavelength of 520 nm emitted by a green LED, and fluorescence was detected through a green fluorescent filter. The detection limit density at this time was 1.0×10³/mm², at which the error bar intersected the background value 3σ (σ is a standard deviation) of the fluorescent detecting device.

From these results, it became clear that although 1/12 of the target number of immobilized antigens (1.2×10⁴/mm²), antigens can be detected at antigen concentrations of 1 pM or less, when fluorescent substances having diameters of φ 300 nm are employed. In addition, it is also clear from these results that detection of antigens in specimens containing antigens at 1 pM is also possible even if the particle sizes of the fluorescent substances are set to be less than 300 nm. In the case that the fluorescent pigment molecules are enveloped at the same density, the fluorescent intensity emitted by each fluorescent substance is proportionate to the cubed radius (r³) of the fluorescent substance. Accordingly, in the case that fluorescent substances having diameters of φ 130 nm are employed, the fluorescent intensity emitted thereby becomes 1/12 that of the fluorescent intensity emitted by fluorescent substances having diameters of 300 nm. However, this fluorescent intensity is sufficient to detect antigens at an antigen concentration of 1 pM. From these findings, the lower limit of the particle size of the fluorescent substances that enable detection of antigens at an antigen concentration of 1 pM is determined to be approximately 130 nm. Note that here, it is assumed that the density of the fluorescent pigment molecules enveloped within the fluorescent substances is substantially uniform.

The greater the particle size of the fluorescent substance, the greater the number of fluorescent pigment molecules enveloped therein becomes. Therefore, the detected fluorescent signal intensities increase along with increases in the particle size, which is advantageous from the viewpoint of detected fluorescent intensities. However, the number of fluorescent substances which can be immobilized onto a predetermined area of a two dimensional surface is limited from the viewpoint of three dimensional interference. If the dynamic range is set to two orders of ten, that is, the upper limit of detectable concentrations is set to 100 pM, the number of fluorescent substances that can be immobilized becomes 1.2×10⁶/mm². At this time, the particle size at which maximum filling density is achieved, assuming that a single fluorescent substance binds with each antigen, is φ 500 nm. For this reason, the upper limit of the particle size for the fluorescent substances is φ 500 nm.

The most preferred range of particle sizes for the fluorescent substances is from 130 nm to 500 nm for the reasons described above.

### Fourth Embodiment

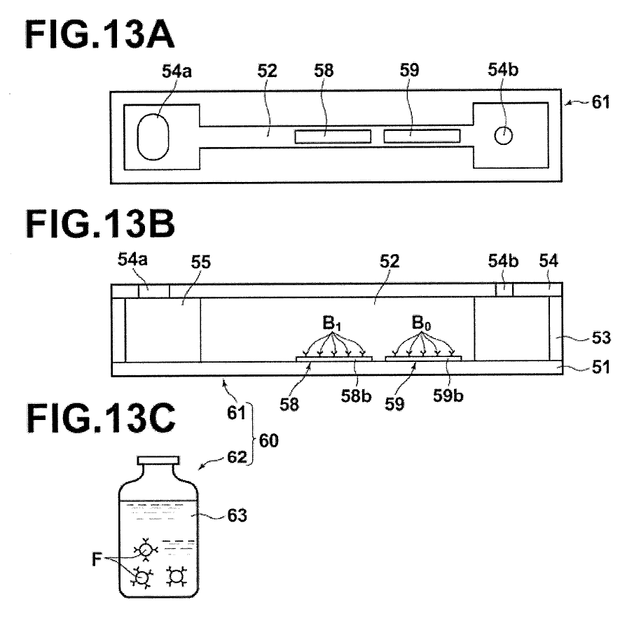

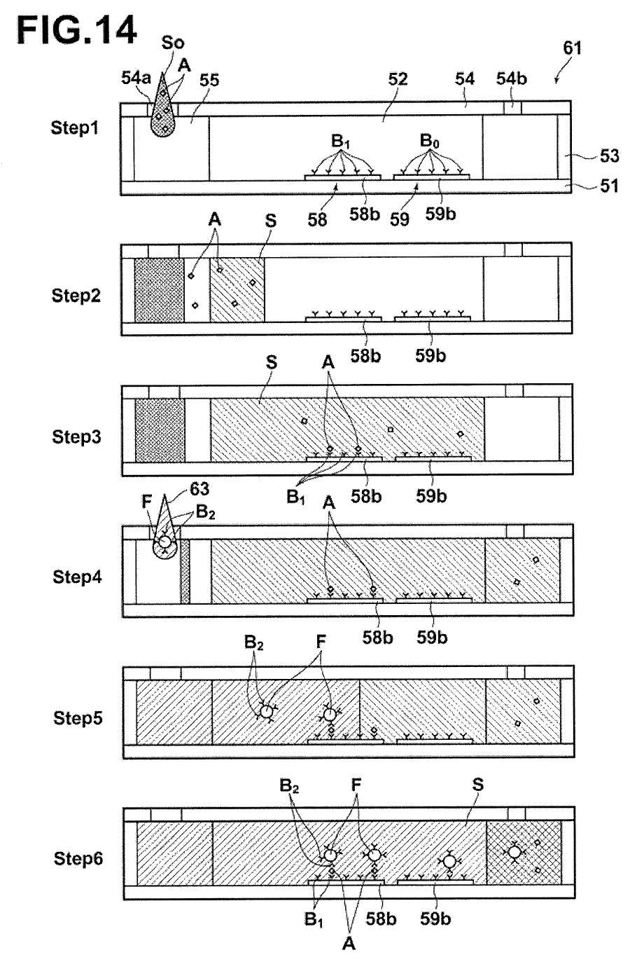

A method that employs a detecting kit 60 according to an embodiment of the present invention will be described as a detecting method of a fourth embodiment of the present invention, with reference to FIG. 13A through FIG. 14. In FIG. 13A through FIG. 14, elements which are the same as those of the sample cell described previously are denoted with the same reference numerals, and detailed descriptions thereof will be omitted.

FIG. 13A is a plan view that illustrates the construction of a sample cell 61 of the detecting kit 60. FIG. 13B is a cross sectional side view of the sample cell 61. FIG. 13C is a diagram that illustrates an ampoule 62 that contains a labeling solution 63.

The detecting kit 60 is equipped with: the sample cell 61; and the labeling solution 63, which is caused to flow through the channel of the sample cell 61 simultaneously with a liquid sample, or after the liquid sample is caused to flow through the channel. The labeling solution 63 includes the fluorescent substance F, which is modified with the secondary antibodies B₂ that specifically bind with the antigens A.

The sample cell 61 differs from the sample cell 50 of the third embodiment described above only in the point that it does not include the physical adsorption area, at which the fluorescent substance F modified with the secondary antibodies B₂ is immobilized.

The fluorescence detecting apparatus illustrated in FIG. 4 and employed to realize the detecting method according to the third embodiment may be employed in a similar manner. If the detecting kit 60 is employed, a detection target substance is labeled by the fluorescent substance, and the second evanescent waves are utilized to excite the fluorescent substance, in the same manner as in the third embodiment. Therefore, highly accurate measurements are enabled.

Sensing that utilizes the fluorescence detecting apparatus 2 and the detecting kit 60 of the fourth embodiment will be described.

The procedures by which an assay is performed by injecting blood (whole blood) to detect whether an antigen to be detected is included therein will be described with reference to FIG. 14.

Step 1: The blood So (whole blood), which is the target of inspection, is injected through the injection opening 54a. Here, a case will be described in which the blood So includes the antigen A to be detected. In FIG. 14, the blood So is represented by the cross hatched regions.

Step 2: The blood So is filtered by the membrane filter 55, and large molecules, such as red blood cells and white blood cells, are separated as residue. Thereafter, plasma S (the blood from which blood cells have been filtered out by the membrane filter 55) leaks out into the channel 52 by capillary action. Alternatively, in order to expedite reactions and to shorten detection time, a pump may be connected to the air aperture 54b, and the plasma S may be caused to flow by suctioning and extruding operations of the pump. In FIG. 14, the plasma S is represented by the hatched regions.

Step 3: The plasma S gradually flows along the channel 52 toward the air aperture 54b, and the antigens A bind with the primary antibodies B₁, which are immobilized onto the first measuring area 58.

Step 4: The labeling solution 63 that includes the fluorescent substance F, which is modified with the secondary antibodies B₂, is injected through the injection opening 54a.

Step 5: fluorescent substance F, which is modified with the secondary antibodies B₂, leaks out into the channel 52 by capillary action. Alternatively, in order to expedite reactions and to shorten detection time, a pump may be connected to the air aperture 54b, and the labeling solution 63 may be caused to flow by suctioning and extruding operations of the pump.

Step 6: The fluorescent substance F gradually flows downstream, the secondary antibodies B₂ bind with the antigens A, and so called sandwich configurations, in which the antigens A are sandwiched between the primary antibodies B₁ and the labeling secondary antibodies B₂ is formed.

In this manner, the blood So is injected through the injection opening 54a, and step 1 through step 6 are performed to form the sandwich configurations, in which the antigens A are sandwiched between the primary antibodies B₁ and the labeling secondary antibodies B₂, on the first measuring area 58. Thereafter, fluorescent signals are detected at the first measuring area 58, to detect the presence and/or the concentration of the antigens. Next, the sample cell 61 is moved in the X direction so as to enable fluorescent signal detection at the second measuring area 59, and fluorescent signals are detected at the second measuring area 59. The fluorescent signals obtained at the second measuring area 59, at which the primary antibodies B₀ that bind with the labeling secondary antibodies B₂ are immobilized, are considered to be fluorescent signals that reflect reaction conditions such as the amount of the labeling secondary antibodies B₂ which has flowed through the channel 52 and the activity thereof. Therefore, if the fluorescent signals obtained at the second measuring area 59 are used as a reference to correct the fluorescent signals obtained at the first measuring area 58, more accurate detection results can be obtained. In the case that the known amount of the labeling substance (fluorescent substance or fine metallic particles) is immobilized onto the second measuring area 59 in advance as described previously, the fluorescent signals obtained at the second measuring area 59 can be used as a reference to correct the fluorescent signals obtained at the first measuring area 58 as well.

An example of a method for modifying the fluorescent substance F with the secondary antibodies, and a method for producing a labeling solution will be described.

A 50 mM MES buffer and a 5.0 mg/mL anti hCG monoclonal antibody solution (Anti hCG 5008 SP-5, by Medix Biochemica) are added to a fluorescent substance solution produced by the steps described previously (with a fluorescent substance having diameters of 500 nm, an excitation wavelength of 502 nm, and a fluorescent wavelength of 510 nm) and agitated. Thereby, fluorescent substances FB are modified with the antibodies.

Next, a 400 mg/mL ESC solution (01-62-0011 by Wako Pure Chemical Industries) is added, and the mixture is agitated at room temperature.

Further, a 2 mol/L glycine solution is added and the mixture is agitated. Thereafter, the mixture is subjected to centrifugal separation, to cause the particles to settle.

Finally, supernatant liquid is removed, PBS (having a pH of 7.4) is added, and the fluorescent substances are redispersed by an ultrasonic cleansing machine. Centrifugal separation is performed again, supernatant liquid is removed, 500 μL of a 1% BSA PBS solution (having a pH of 7.4) is added, and the fluorescent substances are redispersed, to obtain the labeling solution.

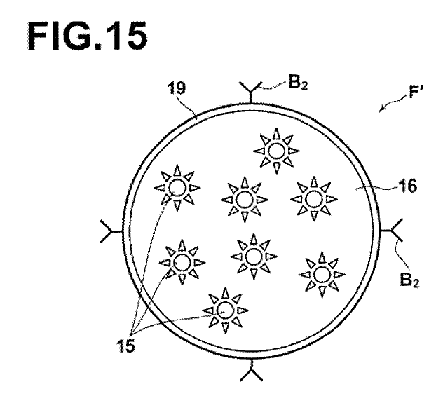

In each of the embodiments described above, the fluorescent substance F, in which the great number of fluorescent pigment molecules 15 are enveloped in the light transmitting material 16 are employed as the fluorescent labels. Alternatively, metal coating films 19 of thicknesses that transmit fluorescence may be provided on the surfaces of the fluorescent substance, as illustrated in FIG. 15. The metal coating films 19 may cover the entireties of the surfaces of the light transmitting material 16, or may partially cover the surfaces of the light transmitting material 16 such that the light transmitting material 16 is exposed at portions. The same materials which are employed for the metal layer may be employed as the material of the metal coating films 19. It is preferable for the thickness of the metal coating films to be approximately 15 nm.

In the case that the metal films 19 are provided on the surfaces of the fluorescent substance F, the second evanescent waves which are generated on the optical waveguide layer 12b of the sensor chip 10 couples with the whispering gallery mode of the metal coating films 19, and the fluorescent pigment molecules 15 within the fluorescent substance F can be excited at higher efficiency. Note that the whispering gallery mode is an electromagnetic wave mode which is locally present on the surfaces of fine spheres such as the fluorescent substance F having a particle diameter less than or equal to φ530 nm, and revolves about the periphery of the spheres.

The metal coating films 19 of the fluorescent substance F′ having the metal coating films 19 may be modified with the second antibodies B₂ that specifically bind with the antigens A, and may be utilized in the detecting methods according to the first through fourth embodiments instead of the fluorescent substance F.

An example of a method for coating the fluorescent substance with the metal coating film will be described.

First, the fluorescent substance is produced by the steps described previously, and the surfaces thereof are modified with PEI (Poly Ethyl Imine).

Next, Pd nano particles having particle sizes of 15 nm (by Tokuriki, average particle size of 15 nm) are adsorbed onto the PEI on the surfaces of the fluorescent substance.

The polystyrene particles, onto which the PD nano particles are adsorbed, are immersed in an immersion gold plating liquid (HAuCl₄ by Kojima Chemical). Thereby, immersion plating that employs the Pd nano particles as catalysts is utilized to form gold films on the surfaces of the polystyrene particles.

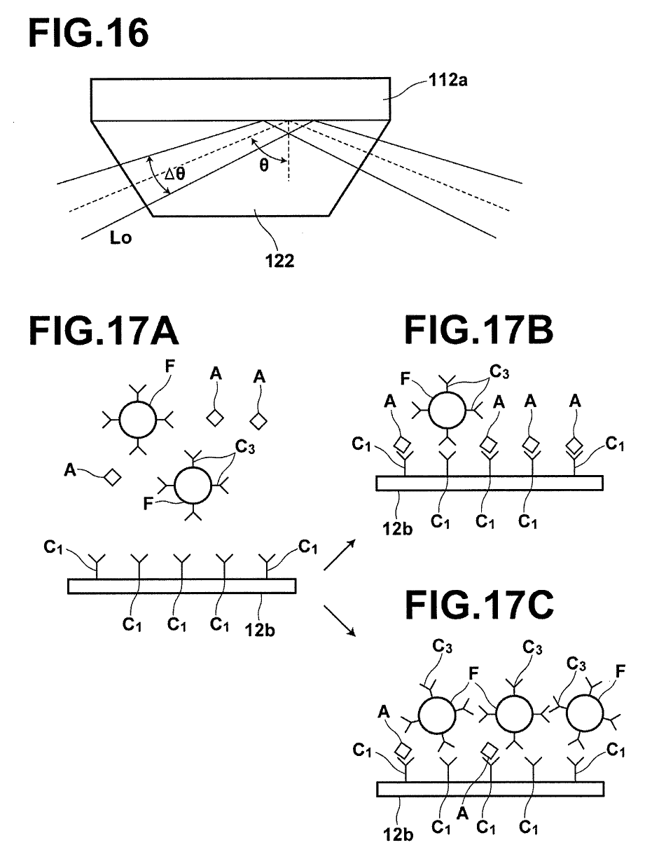

In the embodiments described above, a parallel light beam that enters the interface at a specific angle θ was employed as the excitation light beam Lo. Alternatively, a fan beam (convergence light beam) having an angular width of Δθ with an angle θ at its center may be employed, as schematically illustrated in FIG. 16. In the case that the fan beam is employed, the fan beam enters the interface between a prism 122 and a metal layer 112a on the prism at incident angles within a range from θ−Δθ/2 to θ+Δθ/2. If a resonance angle exists within this angular range, second evanescent waves can be induced on an optical waveguide layer. The refractive index of media on optical waveguide layers changes before and after supply of a sample thereon, and therefore, the resonance angle at which the optical waveguide mode is induced changes. For this reason, in the case that a parallel light beam is employed as the excitation light beam Lo as in the embodiments described above, it becomes necessary to adjust the incident angle of the parallel light beam each time that the resonance angle changes. However, the changes in resonance angles can be dealt with out adjusting the incident angle, by employing the fan beam having the width in incident angles that enter the interface as illustrated in FIG. 16. Note that it is preferable for the fan beam to have a flat distribution with little variations in intensity corresponding to the incident angles.

In addition, assays performed by the sandwich method have been described in the above embodiments. Alternatively, the detecting method, the detecting apparatus, the sample cell, and the detecting kit of the present invention are not limited to being applied to the sandwich method, and may also be applied to perform assays by the competition method.

The competition method will be described briefly with reference to FIGS. 17A through 17C.

As illustrated in FIG. 17A, the fluorescent substance F is modified with secondary antibodies C₃ (third binding substance) that exhibits the same immunological reaction as the antigens A, for example. First antibodies C₁ (first binding substance) that specifically bind with both the antigens A and the secondary antibodies C₃ are immobilized onto the optical waveguide layer 12b. The fluorescent substance F, which is modified with the secondary antibodies C₃, is mixed with the antigens at a predetermined concentration, and caused to react with the primary antibodies C₁, which are immobilized on the optical waveguide layer 12b, in a competitive manner (antigen—antibody reaction). The concentration of the fluorescent substance F during mixing thereof with the antigens A is known.

In the competition method, if the concentration of the antigens A is high, the amount of the second antibodies C₃ that bind with the primary antibodies C₁ is small, as illustrated in FIG. 17B. That is, the number of particles of the fluorescent substance F that bind with the primary antibodies C₁ is small, and therefore the fluorescent intensity is low. On the other hand, if the concentration of the antigens A is low, the amount of the second antibodies C₃ that bind with the primary antibodies C₁ is great, as illustrated in FIG. 17C. That is, the number of particles of the fluorescent substance F that bind with the primary antibodies C₁ is great, and therefore the fluorescent intensity is high. The competition method enables measurement as long as the antigens A have a single epitope. Therefore, the competition method is suited for detection of low molecular weight substances.

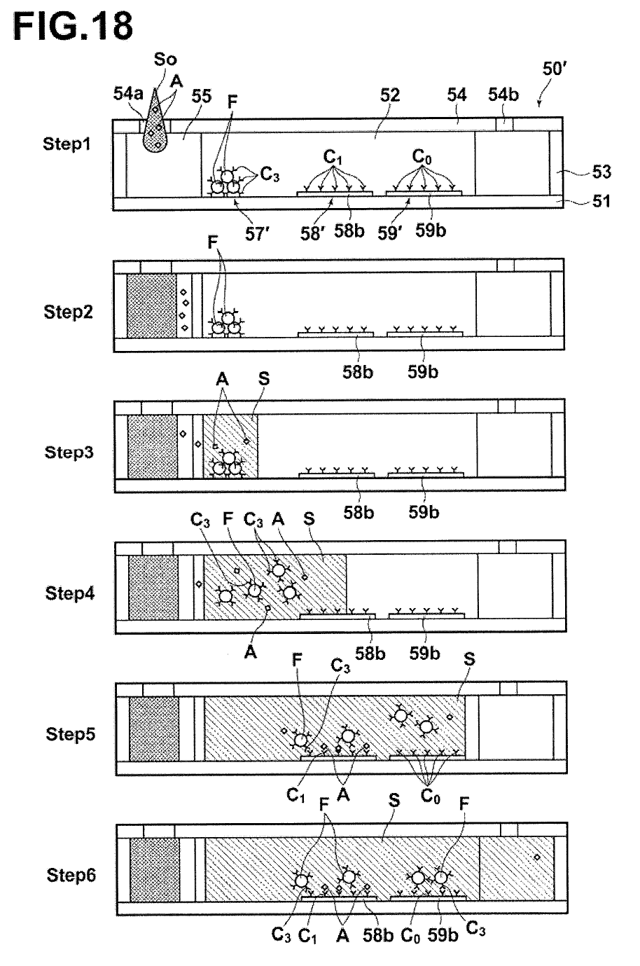

FIG. 18 is a diagram that illustrates the steps of an assay performed employing the competition method, using a sample cell 50′ according to an alternate embodiment of the present invention. The sample cell 50′ may be employed in the fluorescence detecting apparatus 2 of the third embodiment instead of the sample cell 50. The antibodies which are provided within a channel of the sample cell 50′ are different from those which are provided within the channel of the sample cell 50. The sample cell 50′ is applied to assays performed employing the competition method.

In the sample cell 50′, a labeling secondary antibody adsorption area 57′, at which the fluorescent substance F, the surfaces of which are modified with secondary antibodies C₃ (third binding substance) that do not bind to the antigens A to be detected but specifically bind to the primary antibodies C₁, is physically adsorbed, a first measuring area 58′, at which primary antibodies C₁ that specifically bind with the antigens A and the labeling secondary antibodies C₃ are immobilized, and a second measuring area 59′, at which primary antibodies C₀ that do not specifically bind to the antigens A but specifically bind to the labeling secondary antibodies C₃ are immobilized, are provided on the base 51 of the sample cell 50′, in this order from the upstream side of the channel 52.

Au films (not shown) and SiO₂ films (58b and 59b) are provided as the metal layer and the optical waveguide layer on the base 51 at the first measuring area 58′ and the second measuring area 59′, respectively. The primary antibodies C₁ are immobilized on the SiO₂ film 58b at the first measuring area 58′. Primary antibodies C₀, which are different from the primary antibodies C₁, are immobilized on the SiO₂ film 59b at the second measuring area 59′. The first measuring area 58′ and the second measuring area 59′ are of the same construction, except that different primary antibodies are immobilized thereon. The antigens A and the secondary antibodies C₃ bind to the primary antibodies C₁, which are immobilized onto the first measuring area 58′, in a competitive manner. The primary antibodies C₀, which are immobilized onto the second measuring area 59′, do not bind with the antigens A, but directly bind with the labeling secondary antibodies C₃. Thereby, the amount and activity of the labeling secondary antibodies which have flowed through the channel 52, which are factors of variation, and factors of variation due to the enhancing effect of the optical waveguide mode, such as the excitation light emitting optical system 20, the SiO₂ films 58b and 59b, and the liquid sample S, can be detected and utilized for calibration. Note that a known amount of a labeling substance may be immobilized on the second measuring area 59′ instead of the primary antibodies C₀. The labeling substance may be the same as the fluorescent substance, the surfaces of which have been modified with secondary antibodies. Alternatively, the labeling substance may be a fluorescent substance having a different wavelength and of a different size. In this case, only the factors of variation due to the enhancing effect of the optical waveguide mode, such as the excitation light emitting optical system 20, the SiO₂ films 58b and 59b, and the liquid sample S, can be detected and utilized for calibration. Whether to provide the labeling secondary antibodies B₂ or the known amount of the labeling substance at the second measuring area 59 may be determined according to the purposes and method of calibration.

The steps by which an assay is performed by injecting blood (whole blood) into the sample cell 50′ to detect whether an antigen to be detected is included therein will be described with reference to FIG. 18.

Step 1: The blood So (whole blood), which is the target of inspection, is injected through the injection opening 54a. Here, a case will be described in which the blood So includes the antigen A to be detected. In FIG. 18, the blood So is represented by the cross hatched regions.

Step 2: The blood So is filtered by the membrane filter 55, and large molecules, such as red blood cells and white blood cells, are separated as residue.

Step 3: Plasma S (the blood from which blood cells have been filtered out by the membrane filter 55) leaks out into the channel 52 by capillary action. Alternatively, in order to expedite reactions and to shorten detection time, a pump may be connected to the air aperture 54b, and the plasma S may be caused to flow by suctioning and extruding operations of the pump. In FIG. 18, the plasma S is represented by the hatched regions.

Step 4: The plasma S, which has leaked into the channel 52, and the fluorescent substance F, to which the labeling secondary antibodies C₃ are attached, are mixed together.

Step 5: the plasma S gradually flows along the channel 52 toward the air aperture 54b, and the antigens A and the labeling secondary antibodies B₂ bind with the primary antibodies C1, which are immobilized onto the first measuring area 58′ in a competitive manner.

Step 6: A portion of the labeling secondary antibodies C₃ that did not bind with the primary antibodies C₁ at the first measuring area 58′ bind with the primary antibodies C₀, which are immobilized onto the second measuring area 59′. Further, even in the case that the labeling secondary antibodies C₃ which did not bind with the primary antibodies C₁ or the primary antibodies C₀ remain on the measuring areas, the following plasma S functions as a cleansing agent that washes the labeling secondary antibodies C₃, which are floating or non specifically bound onto the plate, away.

In this manner, the blood So is injected through the injection opening 54a, and step 1 through step 6 are performed to cause the antigens A and the secondary antibodies C₃ to bind with the primary antibodies C₁ on the first measuring area 58′ in a competitive manner. Thereafter, fluorescent signals are detected at the first measuring area 58′ and the second measuring area 59′, to detect the presence and/or the concentration of the antigens A.

In the detecting method that employs the sample cell 50′ according to the present embodiment as well, the fluorescent substance is employed as the fluorescent labels, and the second evanescent waves are utilized to excite the fluorescent substance. Therefore, advantageous effects similar to those obtained by the other embodiments described above can be obtained. That is, highly accurate measurements can be performed by a simple method.

### EXAMPLES

Evaluations were conducted regarding the degree of electric field enhancement (the ratio of the intensity of an electric field enhancing field with respect to the intensity of an excitation light beam) and the fluorescent signal intensity (ratios of fluorescent signal intensities of the Examples with respect to the fluorescent signal intensity of a comparative example), for cases in which fluorescent substances (NK-2014 by Hayashibara Biochemical, excitation wavelength: 780 nm, particle size: 200 nm or 500 nm) were immobilized onto the sensor chip portions of the first through third examples described below. Note that in the first through third examples, the wavelengths of the excitation light beams are 780 nm, the material of dielectric prisms is quartz, and the media on the sensor chips are water.

### Example 1

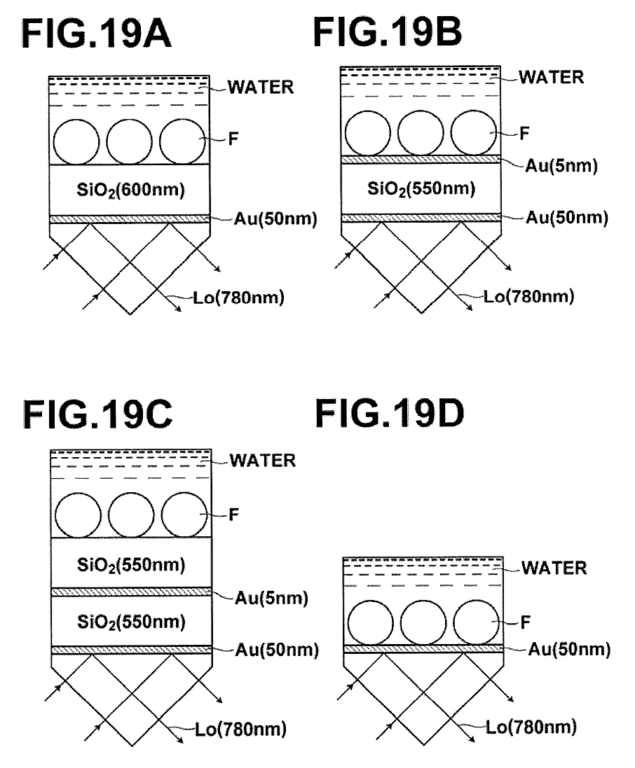

A sensor chip having a gold film (thickness: 50 nm) and an SiO₂ film (thickness: 600 nm), provided on a quartz prism in this order as illustrated in FIG. 19A, was employed.

### Example 2

A sensor chip having a gold film (thickness: 50 nm), an SiO₂ film (thickness: 550 nm), and a gold film (thickness: 5 nm) provided on a quartz prism in this order as illustrated in FIG. 19B, was employed.

### Example 3

A sensor chip having a gold film (thickness: 30 nm), an SiO₂ film (thickness: 550 nm), a gold film (thickness: 30 nm), and an SiO₂ film (thickness: 550 nm) provided on a quartz prism in this order as illustrated in FIG. 19C, was employed.

### Comparative Example

A conventional sensor chip that utilizes electric field enhancement due to surface plasmon was employed as the comparative example. That is, a sensor chip having a gold film (thickness: 50 nm) provided on a quartz prism as illustrated in FIG. 19D was employed to induce surface plasmon.

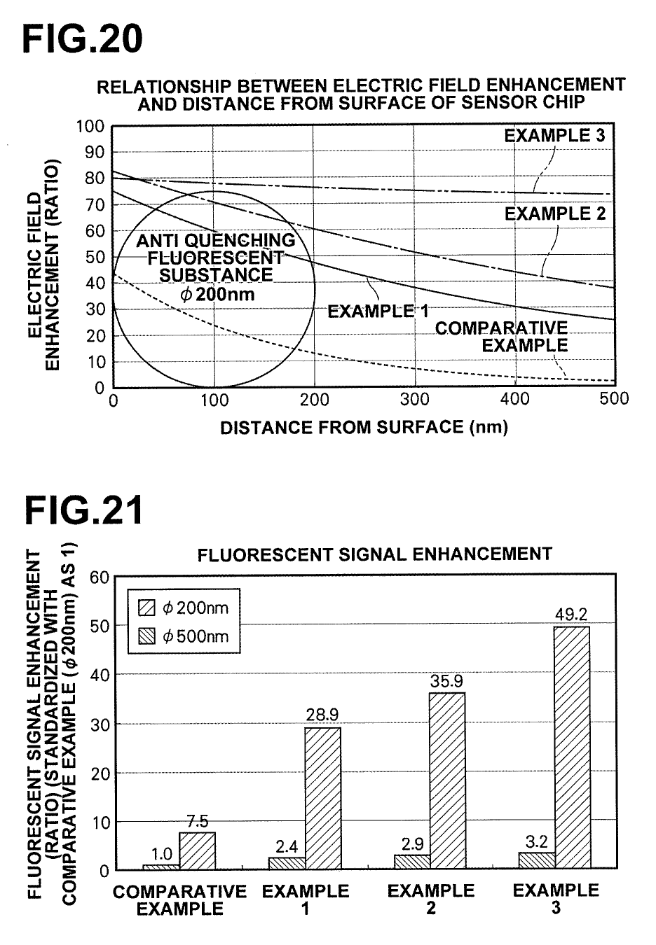

FIG. 20 is a graph that illustrates the relationship between the electric field enhancing intensities and distances from the surfaces of the sensor chips of Examples 1 through 3 and the Comparative Example. As a reference, cases in which the particle size of the fluorescent substance is 200 nm are also illustrated. It can be understood from the graph of FIG. 20 that the second evanescent waves generated due to the optical waveguide mode attenuate more gradually and have longer leakage lengths (distances at which electric field enhancing intensities become 1/e on detection surfaces) than the first evanescent waves generated due to surface plasmon. For example, the leakage length of the Comparative Example is approximately 200 nm. In contrast, the leakage length of Example 1 is approximately 450 nm. In addition, Examples 2 and 3 exhibit leakage lengths which are greater than 500 nm. It was confirmed that the second evanescent waves have longer leakage lengths than the first evanescent waves, and that the leakage length is capable of being lengthened by adopting a thicker laminated structure for the optical waveguide layer.

FIG. 21 is a graph that illustrates the degrees of fluorescent signal enhancement by the sensor chips of Examples 1 through 3 and the Comparative Example. The fluorescence signal intensity which is obtained by the Comparative Example when the fluorescent substance having the particle size of 200 nm is employed as a reference value, and fluorescence signal intensities which are obtained in other cases are expressed as multiples of the reference value. In the Examples that employed the fluorescent substance having the particle size of 200 nm, the degrees of fluorescent signal enhancement were within a range from 2.4 to 3.2. A certain degree of enhancement was obtained, but there were no great differences among the Examples. This is considered to be due to the fact that the number of fluorescent pigment molecules which are excited and emit fluorescence and are enveloped in the fluorescent substance is limited. In cases that the Examples employed the fluorescent substance having the particle size of 500 nm, the degrees of fluorescent signal enhancement were 28.9 for Example 1, 35.9 for Example 2, and 49.2 for Example 3.

As described above, if the detecting methods of the present invention that utilize electric field enhancement by the optical waveguide mode are employed, fluorescent pigment molecules which are enveloped within fluorescent substances can be efficiently excited even in cases that the fluorescent substance has a particle size as large as 500 nm. It was confirmed that decreases and fluctuations in fluorescent signal intensities can be suppressed, and that highly sensitive detection having high quantitative properties is enabled.

### <Design Modifications>

The third and fourth embodiments were described as cases in which the light generated due to excitation of the fluorescent labels was the fluorescence generated by the fluorescent pigment molecules enveloped in the fluorescent substance. However, these embodiments are not limited to this configuration. That is, the third and fourth embodiments of the present invention may also perform measurements by detecting radiant light, which is radiated toward the dielectric plate from surface plasmon at the interface between the metal layer and the dielectric plate, excited by fluorescence generated by the fluorescent labels due to excitation.

What is claimed is:

1. A detecting method, comprising the steps of:
preparing a sensor chip having a metal layer and an optical waveguide layer provided in this order on a surface of a dielectric plate;
causing a sample to contact the optical waveguide layer, to cause an amount of a fluorescent labeling substance corresponding to the amount of a detection target substance included in the sample to bind onto the optical waveguide layer;
causing an excitation light beam to enter the interface between the dielectric plate and the metal layer from the side of the dielectric plate such that conditions for total reflection are satisfied, thereby generating first evanescent waves at the interface;
causing the first evanescent waves to couple with an optical waveguide mode within the optical waveguide layer, thereby generating second evanescent waves at the upper surface of the optical waveguide layer;
exciting fluorescent labels of the fluorescent labeling substance with the second evanescent waves; and
detecting the amount of the detection target substance, based on the amount of light which is generated due to excitation of the fluorescent labels;
a fluorescent substance having fluorescent pigment molecules which are enveloped in a light transmitting material that transmits fluorescence generated by the fluorescent pigment molecules being employed as the fluorescent labels.

2. A detecting method as defined in claim 1, wherein:
the particle size of the fluorescent substance is less than or equal to 5300 nm.

3. A detecting method as defined in claim 2, wherein:
the particle size of the fluorescent substance is within a range from 100 nm to 700 nm.

4. A detecting method as defined in claim 2, wherein:
metal coating films of a thickness that transmit the fluorescence are provided on the surfaces of the fluorescent substance.

5. A detecting method as defined in claim 1, wherein:
the optical waveguide layer is of a laminated structure that includes at least one internal optical waveguide layer constituted by optical waveguiding material.

6. A detecting method as defined in claim 5, wherein:
the laminated structure is of an alternating laminated structure, in which the internal optical wave guide layer and an internal metal layer are provided in this order from the side of the metal layer.

7. A detecting method as defined in claim 1, wherein:
fluorescence, which is emitted by the fluorescent labels due to excitation, is detected as the light which is generated due to the excitation of the fluorescent labels.

8. A detecting method as defined in claim 1, wherein:
radiant light, which is radiated toward the dielectric plate from surface plasmon excited by fluorescence generated by the fluorescent labels due to excitation, is detected as the light which is generated due to the excitation of the fluorescent labels.

9. A detection sample cell, to be utilized in a detecting method that detects the amount of a detection target substance based on the amount of light which is generated due to excitation of fluorescent labels, comprising:
a base having a channel through which liquid samples are caused to flow;
an injection opening provided at an upstream side of the channel for injecting the liquid samples into the channel;
an air aperture provided at a downstream side of the channel for causing the liquid samples which have been injected from the injection opening to flow downstream;
a sensor chip portion provided within the channel between the injection opening and the air aperture, comprising a dielectric plate which is provided as a portion of an inner wall of the channel, a metal layer and an optical waveguide layer which are provided on a predetermined region of the dielectric plate on the sample contacting surface thereof;
a first binding substance that specifically binds with the detection target substance, immobilized onto the optical waveguide layer;
a fluorescent substance modified with one of: a second binding substance that specifically binds with the detection target substance, immobilized onto the channel upstream of the sensor chip portion; and modified with a third binding substance that specifically binds with the first binding substance and competes with the detection target substance.

10. A detection sample cell as defined in claim 9, wherein:
the particle size of the fluorescent substance is less than or equal to 5300 nm.

11. A detection sample cell as defined in claim 10, wherein:
the particle size of the fluorescent substance is within a range from 100 nm to 700 nm.

12. A detection sample cell as defined in claim 10, wherein:
metal coating films of a thickness that transmit the fluorescence are provided on the surfaces of the fluorescent substance.

13. A detection sample cell as defined in claim 9, wherein:
the optical waveguide layer is of a laminated structure that includes at least one internal optical waveguide layer constituted by optical waveguiding material.

14. A detection sample cell as defined in claim 13, wherein:
the laminated structure is of an alternating laminated structure, in which the internal optical wave guide layer and an internal metal layer are provided in this order from the side of the metal layer.

15. A detecting kit to be utilized in a detecting method that detects the amount of a detection target substance based on the amount of light which is generated due to excitation of fluorescent labels, comprising:
a detection sample cell equipped with: a base having a channel through which liquid samples are caused to flow; an injection opening provided at an upstream side of the channel for injecting the liquid samples into the channel; an air aperture provided at a downstream side of the channel for causing the liquid samples which have been injected from the injection opening to flow downstream; a sensor chip portion provided within the channel between the injection opening and the air aperture, comprising a dielectric plate which is provided as a portion of an inner wall of the channel, a metal layer and an optical waveguide layer which are provided on a predetermined region of the dielectric plate on the sample contacting surface thereof; a first binding substance that specifically binds with the detection target substance, immobilized onto the optical waveguide layer; and
a labeling solution which is caused to flow into the channel after the liquid sample, including a fluorescent substance modified with one of: a second binding substance that specifically binds with the detection target substance, immobilized onto the channel upstream of the sensor chip portion; and modified with a third binding substance that specifically binds with the first binding substance and competes with the detection target substance.

16. A detecting kit as defined in claim 15, wherein:
the particle size of the fluorescent substance is less than or equal to 5300 nm.

17. A detecting kit as defined in claim 16, wherein:
the particle size of the fluorescent substance is within a range from 100 nm to 700 nm.

18. A detecting kit as defined in claim 16, wherein:
metal coating films of a thickness that transmit the fluorescence are provided on the surfaces of the fluorescent substance.

19. A detecting kit as defined in claim 15, wherein:
the optical waveguide layer is of a laminated structure that includes at least one internal optical waveguide layer constituted by optical waveguiding material.

20. A detecting kit as defined in claim 19, wherein:
the laminated structure is of an alternating laminated structure, in which the internal optical wave guide layer and an internal metal layer are provided in this order from the side of the metal layer.
